(19) United States
(12) Patent Application Publication
(10) Pub. No.: US 2014/0200928 A1
(43) Pub. Date: Jul. 17, 2014

(54) METHODS AND APPARATUS FOR AUTOMATED WEB PORTAL AND VOICE SYSTEM DATA AGGREGATION

(71) Applicant: Advance Response, LLC., San Jose, CA (US)

(72) Inventors: Timothy Watanabe, San Jose, CA (US); Kenneth Poray, Point Pleasant Beach, NJ (US); Craig So, Morgan Hill, CA (US); Tiffany Eastley, Cary, NC (US); Vince Uyeda, Monterey, CA (US); Mark Tsutsui, Morgan Hill, CA (US); James Han, San Jose, CA (US)

(73) Assignee: Advance Response, LLC., San Jose, CA (US)

(21) Appl. No.: 14/216,008

(22) Filed: Mar. 17, 2014

Related U.S. Application Data
(63) Continuation-in-part of application No. 13/715,809, filed on Dec. 14, 2012.
(60) Provisional application No. 61/792,881, filed on Mar. 15, 2013.
(60) Provisional application No. 61/570,828, filed on Dec. 15, 2011.

(51) Int. Cl. G06Q 40/08; G06Q 50/22

(52) U.S. Cl. CPC G06Q 40/08; G06Q 50/22
USPC 705/4

(57) ABSTRACT

Methods and apparatus for automating the process for researching medical claims and/or eligibility, as well as standardizing and analyzing the resulting data are. These methods include automated processes for researching an insurance claim, comprising steps of interactively and recursively querying search fields in a web portal(s) and/or phone system(s), aggregating the information from multiple sources into a standardized format in a database table(s). This data can be used to generate analytics, predictive analysis and reports for the medical provider and/or payers. This application also sets forth multiple communication standards for exchanging data over a phone or computer system. Other embodiments are described.

### CROSS-REFERENCE TO RELATED APPLICATIONS

This application claims priority of U.S. Application Ser. No. 61/792,881, filed on Mar. 15, 2013. This application is also a continuation-in-part of U.S. application Ser. No. 13/715,809, filed on Dec. 14, 2012, which claims priority of 61/570,828, filed on Dec. 15, 2011. The entire disclosures of all of these applications are incorporated herein by reference.

### FIELD

This application relates generally to methods and systems for methods and apparatus for automating medical insurance claim and eligibility research. In particular, this application relates to methods and apparatus for automating the process of researching claim information across web and phone systems, aggregating and standardizing data from multiple sources, and analyzing data related to insurance claims and eligibility/benefits, including predicting and accelerating the next action.

### BACKGROUND

Health insurance claims take a standard path comprising verification of patient eligibility, coding, submission and adjudication to payment and notification. At each step of the path, there are variables; however, most health providers and insurers/payers follow the same basic procedures. Claim submission is the first part of the claim processing path. Following a patient encounter, medical coders/billers fill out patient information and designate associated diagnosis codes (ICD-9, or ICD-10 when enacted) and procedure codes (CPT) into a Health Insurance Claim Form (HICFA), or “Claim.” Claims are submitted to commercial and/or government insurance payers by medical providers for each medical service provided. Depending on the type of insurance plan and if the provider of services is in-network or out-of-network, the claim may be submitted by the provider or the patient. In the adjudication process, the insurer determines who is responsible for payment and the amount. Providers may submit charges for any amount, but claims are often adjudicated to pay only the amount considered allowable by the insurance payer pursuant to the term of the member's insurance plan and/or a provider contract, either “in-network” for contracted providers, or “out-of-network” for providers not under contract with the payer. If the insurance plan has a co-payment insurance provision, a percentage of the claim amount(s) are paid to the provider and the patient is then responsible for paying the rest. Adjudication is often electronic but may require manual intervention by a claims processer, depending on the service, amount of the submitted claim or if the claim is incomplete. After claims adjudication, the payment is sent to the provider and/or patient, as applicable. In most cases the payment is reimbursed directly to the provider through an electronic transfer and by check to the patient; however, in certain cases, the claim may need additional research to be performed. The research can include a broad range of data including a combination of: claim data, explanation of benefits (reason codes/messages), eligibility data, benefit/plan/coverage data, deductible data, co-insurance data, co-pay data, coordination of benefit data, (pre)authorization data, and payment/check data. One example of a reason that additional research may be required is when a claim has an outstanding balance, and upon further research, the balance is determined to be the patient's responsibility. Another cause for additional research is when a claim is denied for various reasons, such as incomplete or incorrect diagnosis or procedure codes, discrepant information between the provider and payer system records, medical necessity, and/or missing documentation, any of which results in no payment being sent. In these cases, the provider biller or outsourced billing agent must spend significant time to research the reason for non-payment. Another example is to research a patient's general eligibility for coverage by the respective insurance company, coverage of specific types of services and deductible, for instance, $100 deductible following which the insurance company will pay 80% of the balance for a particular procedure. Billers typically follow up via one or more of three different channels: 1) search for the claim on a payer's website, or other third party site; 2) call the payer's self-service IVR system; and/or 3) call to speak with a payer's provider support agent. Once the biller has gathered information, the biller will then determine how to resolve the issue and whether the claim must be modified for resubmission, or simply re-billed in the event that a claim may not have been received by the payer(s). Ultimately, if and when the claim is allowed, the patient receives an explanation of benefits (EOB) statement, and the provider receives a remittance (EDI Form 835, often simply referred to as an “835”). The EOB and 835 display claims details, including how the claim was paid, patient balance, and the date of service and the procedure or service code of the service.

### SUMMARY

This application relates to methods and systems for automating medical insurance claim and eligibility research. These methods include automated processes for researching an insurance claim, comprising steps of importing patient account and/or medical claim information from a medical provider into the automated system, interactively and recursively querying search fields on a specified payer web portal(s) and/or phone system(s), aggregating the claim and/or eligibility information from multiple sources into a standardized format in a database table(s), including data about the account status, claim status, eligibility, benefits, plan, coverage, deductible, co-insurance, co-pay, (pre)authorization, coordination of benefit, and payment/check information, biller activity and other general information about the activity associated with the claim resolution process. This data can be used to report back to the medical provider and/or related billing services entity, in order to benchmark and/or improve the information used to create and process the claim. The system can also be used to evaluate claim data and apply predictive analytics for approaches to resolve the claim. This application also sets forth multiple communication standards for exchanging data over a phone or computer system.

### BRIEF DESCRIPTION OF THE DRAWINGS

The following description can be better understood in light of the Figures, in which:

FIG. 1 depicts some embodiments of the communication systems;

FIG. 2 illustrates an exemplary computer apparatus that can be used in some embodiments in the communication systems;

FIG. 3 illustrates an exemplary network that can be used in some embodiments in the communication systems;

FIG. 4 depicts some embodiments of the communication systems with minimal involvement by a user;

FIG. 5 depicts some embodiments of the communication systems with increased involvement by a user;

FIG. 6 depicts some embodiments of the communication systems with even more increased involvement by a user;

FIG. 7 depicts some embodiments of multiple users communicating with each other using the communication system;

FIG. 8 shows some embodiments of a user interface that can be used in the communication system;

FIG. 9 shows some embodiments of methods for automating medical insurance claims and eligibility research using combined web and voice research;

FIG. 10 shows some embodiments of methods for automating medical insurance claims and eligibility research using data retrieved from a voice system;

FIG. 11 shows some embodiments of methods for automating medical insurance claims and eligibility research using data retrieved from a voice system;

FIG. 12 shows some embodiments of methods for automating medical insurance claims and eligibility research using data retrieved from a voice system;

FIG. 13 shows some embodiments of methods for automating medical insurance claims and eligibility research using data compiled from web portal content;

FIG. 14 shows some embodiments of methods for automating medical insurance claims and eligibility research using data normalized from disparate sources of data;

FIG. 15 shows some embodiments of methods and apparatus for analyzing agent behavior;

FIG. 16 shows some embodiments of methods for automating medical insurance claims and eligibility research using data that has been mapped from a web site into database values; and

FIGS. 17A and B shows some embodiments of methods for automating medical insurance claims and eligibility research using data exchanged via automated interactive voice communications.

The Figures illustrate specific aspects of the methods and systems for communicating. Together with the following description, the Figures demonstrate and explain the principles of the methods and apparatus used by these methods. In the drawings, the thickness of layers and regions are exaggerated for clarity. The same reference numerals in different drawings represent the same element, and thus their descriptions will not be repeated.

### DETAILED DESCRIPTION

The following description supplies specific details in order to provide a thorough understanding of the related methods and apparatus. Nevertheless, the skilled artisan would understand that the apparatus and associated methods of making and using the apparatus can be implemented and used without employing these specific details. Indeed, the apparatus and associated methods can be placed into practice by modifying the illustrated apparatus and associated methods and can be used in conjunction with any other apparatus and techniques conventionally used in the industry. For example, while the description below focuses on using the communication system for automating, standardizing and analyzing the process for researching information about medical insurance claims, it could be used in and applied to other types of research and data aggregation processes, like insurance quotes, other types of insurance claims, real estate listings, travel research, business or stock information, weather information or mortgage servicing transactions.

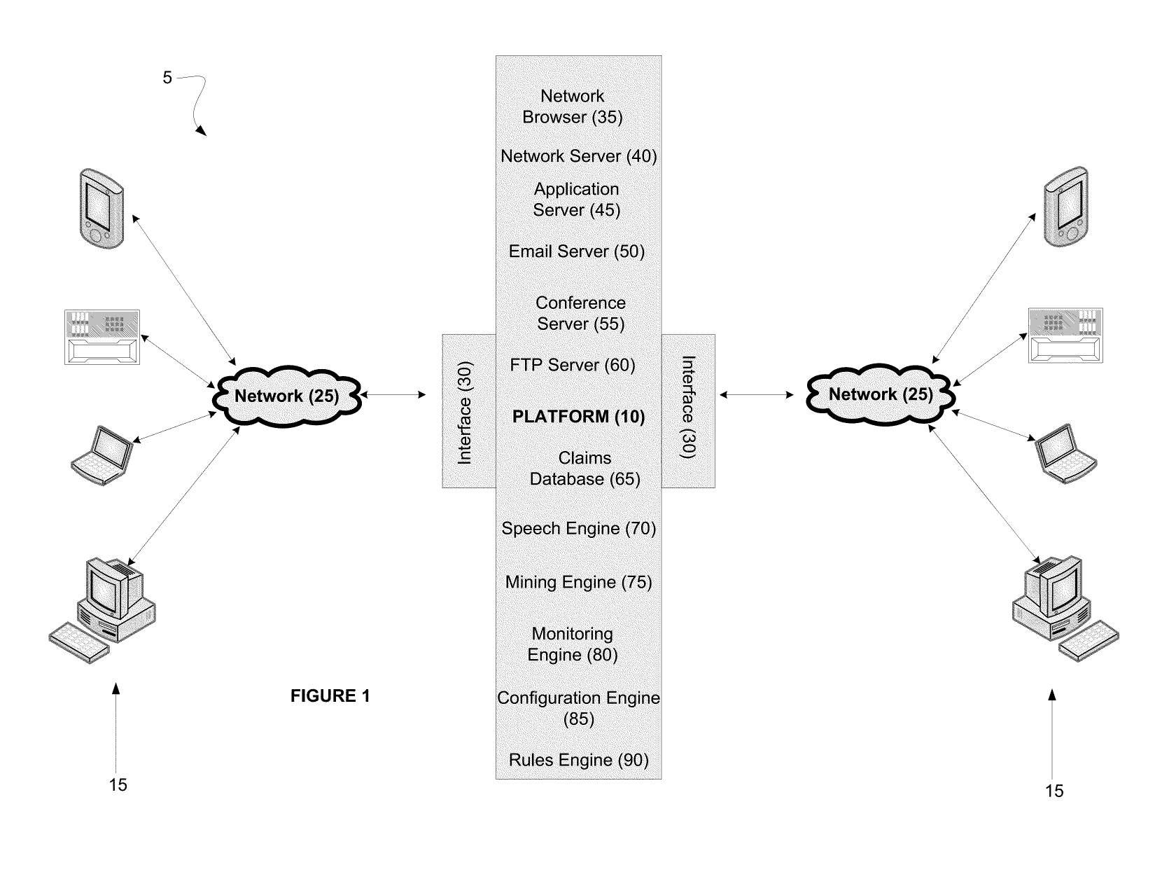

Some embodiments of the methods and systems for researching and analyzing healthcare insurance claims are shown in FIGS. 1-17. In these embodiments, the systems and methods comprise and utilize a platform that functions to send and/or receive encrypted or unencrypted data, text, audio, visual, or any other digital information to and/or from multiple users. In the embodiments shown in FIG. 1, the system 5 comprises a platform 10 that is in communication with various users using any combination of user devices 15 through a communications network 25. Prior to discussing the details of system 5, it should be understood that the following description is presented largely in terms of processes and operations that may be performed by any known computing components. These computing components, which may be grouped in a single location or distributed over a wide area, generally include computer processors, memory storage devices, display devices, input devices, etc. In circumstances where the computer components are distributed, the computer components are accessible to each other via communication links, such as those illustrated in FIG. 1. The system 5 could equally operate within a computer system having a fewer or greater number of components than those illustrated in the Figures. Thus, the depiction of system 5 should be taken as illustrative and not limiting. For example, the system 5 could implement various services components and peer-to-peer network configurations to implement at least a portion of the processes. The solution can be used in an “on premise” solution, as well as in a software-as-a-service configuration.

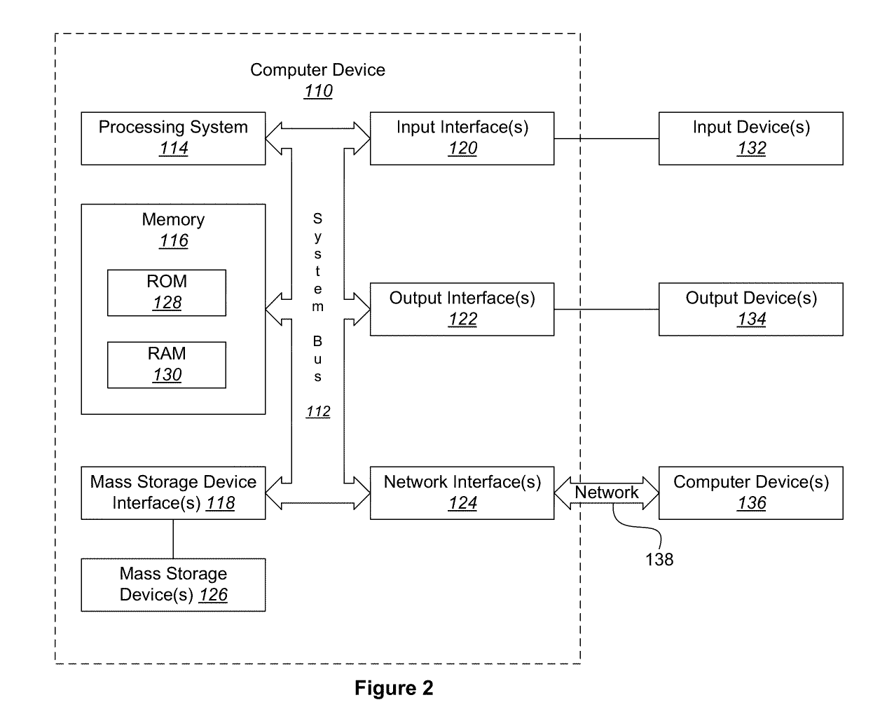

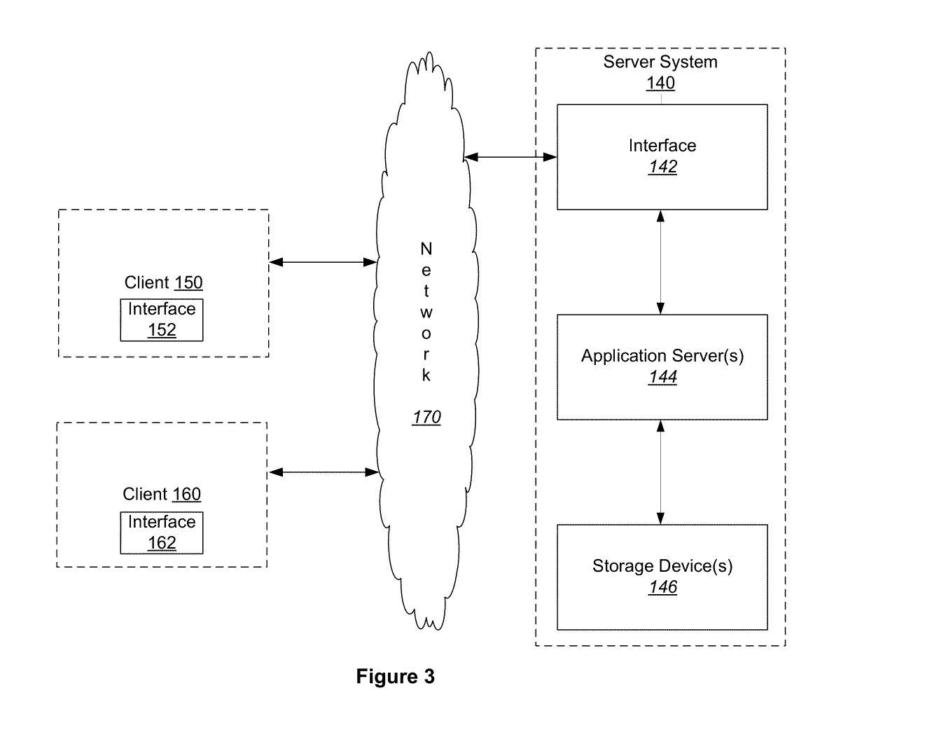

In some embodiments, FIGS. 2-3 illustrate one computing environment in which the system may be implemented. These embodiments contain one or more computer readable media that may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 2, the system includes computer device 110, which may be any type of computer or computing device. For example, computer device 110 may be a personal computer, a notebook computer, a tablet computer, a personal digital assistant (“PDA”), smart phone, or other hand-held device, a workstation, a minicomputer, a mainframe, a supercomputer, a multi-processor system, a network computer, a processor-based consumer electronic device, or the like.

The computer device 110 includes system bus 112, which may be configured to connect various components thereof and enables data to be exchanged between two or more components. The system bus 112 may include one of a variety of bus structures including a memory bus or memory controller, a peripheral bus, or a local bus that uses any of a variety of bus architectures. Typical components connected by system bus 112 include processing system 114 and memory 116. Other components may include one or more mass storage device interfaces 118, input interfaces 120, output interfaces 122, and/or network interfaces 124.

The processing system 114 includes one or more processors, such as a central processor and optionally one or more other processors designed to perform a particular function or task. It is typically processing system 114 that executes the instructions provided on computer readable media, such as on memory 116, a magnetic hard disk, a removable magnetic disk, a magnetic cassette, an optical disk, or from a communication connection, which may also be viewed as a computer readable medium.

The memory 116 includes one or more computer readable media that may be configured to include or includes thereon data or instructions for manipulating data, and may be accessed by processing system 114 through system bus 112. The memory 116 may include, for example, ROM 128, used to permanently store information, and/or RAM 130, used to temporarily store information. ROM 128 may include a basic input/output system (“BIOS”) having one or more routines that are used to establish communication, such as during start-up of computer device 110. RAM 130 may include one or more program modules, such as one or more operating systems, application programs, and/or program data.

One or more mass storage device interfaces 118 may be used to connect one or more mass storage devices 126 to system bus 112. The mass storage devices 126 may be incorporated into or may be peripheral to computer device 110 and allow computer device 110 to retain large amounts of data. Optionally, one or more of the mass storage devices 126 may be removable from computer device 110. Examples of mass storage devices include hard disk drives, magnetic disk drives, tape drives and optical disk drives. A mass storage device 126 may read from and/or write to a magnetic hard disk, a removable magnetic disk, a magnetic cassette, an optical disk, or another computer readable medium. Mass storage devices 126 and their corresponding computer readable media provide nonvolatile storage of data and/or executable instructions that may include one or more program modules such as an operating system, one or more application programs, other program modules, or program data.

One or more input interfaces 120 may be employed to enable a user to enter data and/or instructions to computer device 110 through one or more corresponding input devices 132. Examples of such input devices include a microphone, a joystick, a game pad, a satellite dish, a scanner, a camcorder, a digital camera, a tactile input device, and the like. Some examples of tactile input devices can include a keyboard and alternate input devices, such as a mouse, trackball, light pen, stylus, touchpad, touch-screen, or any other suitable pointing device. Similarly, examples of input interfaces 120 that may be used to connect the input devices 132 to the system bus 112 include a serial port, a parallel port, a game port, a universal serial bus (“USB”), a firewire (IEEE 1394), or another interface such as data that can be entered via a phone using a voice.

One or more output interfaces 122 may be employed to connect one or more corresponding output devices 134 to system bus 112. Examples of output devices include a speaker, a printer, a visually perceptible output device (e.g., a monitor, display screen, or any other suitable visualization device), and the like. A particular output device 134 may be integrated with or peripheral to computer device 110. Examples of output interfaces include a video adapter, an audio adapter, a parallel port, and the like.

One or more network interfaces 124 enable computer device 110 to exchange information with one or more other local or remote computer devices, illustrated as computer devices 136, via a network 138 that may include hardwired and/or wireless links. Examples of network interfaces include a network adapter for connection to a local area network (“LAN”) or a modem, wireless link, or other adapter for connection to a wide area network (“WAN”), such as the Internet, or phone/cellular network for instance 3G. The network interface 124 may be incorporated with or peripheral to computer device 110. In a networked system, accessible program modules or portions thereof may be stored in a remote memory storage device. Furthermore, in a networked system computer device 110 may participate in a distributed computing environment, where functions or tasks are performed by a plurality of networked computer devices.

The system may be operated in networked computing environments with many types of computer system configurations. FIG. 3 represents some embodiments of a networked environment that includes clients 150 and 160 connected to a server system 140 via a network 170. While FIG. 3 illustrates an embodiment that includes two clients connected to the network, alternative embodiments include one client connected to a network or many clients connected to a network. Moreover, some embodiments also include a multitude of clients throughout the world connected to an electronic network, where the network can be a wide area network, such as the Internet.

Returning to FIG. 1, the user devices 15 comprise any communication device known in the art. In some embodiments, the user devices 15 comprises any computing device like a desktop computer, a laptop computer, a server, a telephone, a mobile or cellular phone, a smart phone, a personal digital assistant (such as a Palm Pilot device), an automated calling system, any known interactive voice response (IVR) device, an answering machine, a portable electronic device, a mobile hand held device, any electronic device containing computing software or an application programming interface (API), 3^{rd} party software (like Lytec, Allscripts, etc), other service providers such as multi-payer solutions like NaviNet, or any combinations thereof. The user's device 15 can communicate using any technology, operating system, or software configuration known in the art.

The communication by the user's device 15 can be made using any technologies known in the art. These technologies include wireless transfers (i.e., Bluetooth, Wi-Fi, Wi-Max, cellular phone, etc.), network transfers via any protocol, and bus transfers between devices attached to the same computer processing unit via connectivity such as USB port, FireWire IEEE-1394, serial port, parallel port, PCMCIA, CompactFlash, SecureDigital, or like ports or means of electronic connectivity.

In other embodiments, the user devices 15 comprise multiple devices or components sufficient to create a system. In these embodiments, the multiple devices/components are combined into creating a computing environment in which the user operates. Examples of user systems include a LAN, WAN, cellular networks, phone lines, internet, intranet, or the like. One particular example of a user system comprises the internal computing network of an insurance company, a hospital, or a doctors' office.

The system 5 is not limited to just communicating with users. In some embodiments, the system 5 can communicate with non-users through their devices and/or systems. Non-user systems and/or devices can contain software including, for example, Lytec, AllScripts, etc. Examples of non-users systems/devices include system software like Lytec and AllScripts, insurance company data services (sometimes web services or EDI), or IVRs.

The network 25 comprises any electronic communication network known in the art that, in certain configurations, is capable of using the communication employed by the user (or non-user) device(s) (or systems). In some embodiments, the communication network 25 comprises a wide area network, a local area network, a telephone/cellular network, and internet services like email, instant messaging, SMS, or combinations thereof.

The types of communication channels in the network 25 can include any of those known in the art. These communication channels include any phone communication (including interactive phone communication through speech or touchtone recognition, IVR, or text-to-speech playback), email, text messaging, SMS, instant messaging (IM), internet communication (such as through a web interface), voice mail, video communication (i.e., video conferencing or Skype conference), system APIs, database calls, or any communication that connects/transfers people or systems to communicate to each other using any type of electronic device or communication mechanism.

The platform 10 can coordinate the sending and/or receiving of data (including any needed digital content) between multiple users using multiple communication channels at the same time. In some configurations, the platform can trigger outbound communications, including interactive calls, chat messages, emails, SMS messages, API integration, etc. These can be coordinated with inbound communications, including interactive calls, chat messages, emails, SMS messages, API integration, etc. that are received by the platform 10. In some embodiments, the outbound communications can automatically retrieve information from any of the users (including individuals via a phone, IVRs, systems, etc.) and make that info available via reports which can include recordings. For instance, the platform could call into an insurance company and get a claims status via an agent or via IVR, can record what was said, and the provider agent could listen to the recording or view the report using the platform whenever desired.

The communication functionality of the platform 10 can include generation of alerts, notifications, reports, user-configurable static or dynamic applications, speech recognition, touchtone recognition, speech-to-text generation, text-to-speech playback, xml, web pages/applications, or any combination thereof that may or may not be integrated together. For example, if a user needs to answer 10 questions and the user answers 7 of them on the phone, when the user logs onto the web, the user can simply answer the remaining 3 without having to start the answering process over from the beginning. The platform 10 comprises any component or combination of components described above that provides any—or all—of these functions. In some configurations, the platform may use a single or multiple functions at a time and those functions can—if desired—interact with each other. In other configurations, all of the functions are capable of working at the same time and interacting with each other. So, for example, if the platform 10 was used to create an application that interacts with a user on a specific topic (i.e., it asks a user “Did you feed the dog?”), that application can be simultaneously used in any or all of the following applications: outbound phone/VOIP, inbound phone/VOIP, outbound email/web, inbound email/web, outbound SMS, etc. Thus, if a user receives a voice mail on this topic from the platform, the user can respond to the voice mail via the web or IM or email or whatever communication channel that works best for them.

One of the components that can be contained in the platform 10 includes a network browser 35. This browser can be used to view, organize, analyze, and utilize the information and data in the platform 10. In some configurations, the browser 35 can control the software which a system operator can use to control the operation of the platform 10. In some embodiments, the network browser 35 can comprise an HTML browser, an XML browser, an HL7 browser, a VXML browser, or combinations thereof.

Another component that can be contained in the platform 10 includes a server. Any type of server known in the art can be used. Examples of servers that can be used include a computer running a UNIX-style operating system, a computer running a Microsoft Windows operating system, Macintosh, or a personal computer workstation. The server can comprise any storage component on which digital information can be stored. Examples of storage components include optical storage discs, DVD-RAM discs, solid state storage devices, and traditional magnetic hard disc drives. In some configurations, the storage component could be a server in a network operations center (NOC).

Another example of a storage component includes any known database (or combination of databases). The database stores any desired information, including information regarding the digital content and any user interaction with the platform. For example, the database stores data regarding any specific user device(s). The database can also store sales information, user information, transactional information, reporting information, data warehousing, etc. As an example of the data warehousing, the platform can store any or all of the desired interactions (for instance, call recordings) as well as the static application used to contact/interact with the user during a transaction. The database may include a Microsoft SQL database, a Microsoft Access database, an Oracle database, a MySQL database or combinations thereof.

In some aspects, multiple servers may be connected together to make a server cluster. Using a server cluster permits sharing information about the data stored on each server and each transaction or event the server has recorded. By using a server cluster, the system 5 is always operational, regardless of the location of a particular component on the network that connects the components (such as the internet). The server cluster can contain a primary cluster, which handles all critical tasks, with minor functions being routed to a secondary cluster. With this configuration, if the primary cluster is not operational, most functions can be handled by the secondary cluster. A server cluster also allows for large-scale deployment and interoperability, as well as data that can be stored on the network in multiple points of co-location. In some configurations, there will be server redundancy as well as site redundancy for the servers.

The software components required for operating the server may be included on a single server or on multiple servers, with each server implementing one or more tasks and communicating among themselves using standard networking protocols. Non-limiting examples of the server-focused tasks using the software components that may be implemented on one or more servers including an e-mail server; network server; application server; conference server; ftp server; file server; user device server; speech/voice server, content management server; content synchronization server; chat server, reports server, SMS server; content security server; and advertising/promotional message server.

In some embodiments, such as those depicted in FIG. 1, the platform 10 can contain a network server 40. The network server 40 organizes and manages the data and information coming in from, and out to, the network 25. Thus, the network server can serve to manage all of the communications in the platform 10.

In the embodiments depicted in FIG. 1, the platform 10 can also contain one or more application servers 45. The application server 45 manages the operation of the various software applications and/or paths/workflow that reside on the platform 10.

In the embodiments depicted in FIG. 1, the platform 10 can also contain one or more email servers 50. The email server 50 manages and organizes all of the email related information and data coming into and out of the platform 10 through any email communication method.

In the embodiments depicted in FIG. 1, the platform 10 can also contain a conference server 55. The conference server 55 manages the operation of any conference between an operator of the platform and any user (or combination of users) or any group of users.

In the embodiments depicted in FIG. 1, the platform 10 can also contain an FTP server 60. The ftp server 60 manages and organizes all of the information and data coming into and out of the platform 10 through a file transfer protocol (FTP) communication method.

In some configurations, the platform 10 can also contain a claims database 65 that manages and stores data about healthcare insurance claims. The types of data that can be stored (and then delivered to a user) are virtually unlimited. Examples include eligibility, benefit, plan, coverage, deductible, co-insurance, co-pay, coordination of benefits, authorization, pre-authorization, bulk check data, etc. The format in which the digital content is stored is also virtually unlimited. The data can also be provided in any known computer or human language. The data may be provided internally (by the entity that controls or operates the platform 10), or externally by one or more third parties that may be submitting, processing, and/or paying the health insurance claim.

The servers can insert the data into any desired communication. For example, the database could insert a text file into a phone call or could insert an audio file into an email, SMS, chat, API, or text message. In some embodiments, the data is inserted into the desired communication based on one or more characteristics that match the communication. For example, text from an excel spreadsheet or other system database/API can be inserted into an outbound call, thereby customizing the information spoken to the user. For example, an outbound call can contain the statement “Hello, this is Dr. Smith's office. [John Doe] has an appointment on [Monday, January 15^{th}] at [3:30 pm].” In this case, the various values within the brackets [ ] are taken from an excel spreadsheet and then inserted into the phone/voice application.

In some configurations, the platform 10 can contain a rules engine 90 which matches the data with the communication based on these characteristics. For example, if a specific user prefers email when interacting with the platform, when it's time to contact that user, the rules engine will determine that it could send them an email instead of calling them. Thus, the platform contains a way for users to input their personal information as well as preferred communication mechanisms. This personalization can be configured by time, event, or over-ride values.

In some embodiments, the platform 10 also contains a voice platform and/or speech engine 70, as shown in FIG. 1. The speech engine 70 operates both as a speech recognition engine which can automatically convert speech into text, as well as an automated speech generation engine which can automatically convert text into speech. Thus, the speech engine 70 can accepts voice and DTMF (button presses) as input and navigate the voice options accordingly.

The platform 10 can also contain a mining (or reporting) engine 75 as shown in FIG. 1. The mining engine operates to analyze the data present in—or flowing through—the platform 10 from all of the various communications. The analyzed data can then be used for many purposes, including optimizing the operation of the platform 10, customer specific reports, setting rules for the data/information that would trigger an alert or a notification, recipient engagement/progress results, or a combination thereof.

The platform 10 can also contain a monitoring engine 80. The monitoring engine 80 operates to monitor the operation of the various components of the platform 10. The monitoring engine therefore contains API's for data integration and data services (including web services, RSS, email, XML, API, FTP), with integrated triggering services for initiating any outbound communication via phone, job manager, reporting/statistics/logging service, billing and accounting service, multi-tenancy manager, user account (profile) manager which allows for user profiles to be established defining the various ways an individual may be contacted based on preferred device and based on time of day or day of week, resource and configuration manager, and scheduling service manager.

In some embodiments, the monitoring engine 80 allows any information or data associated with any user, and/or that user's activities (“user data”) to be securely and appropriately observed by and/or communicated to other parts of the platform, others users, and/or the third parties. User data, among other things, may comprise of information about the user. For instance, user ID, password, and phone number for purposes of connecting various users together. It can also store the user's respective role for things like feature or report accessibility. It can also store preferred contact protocols. For example, for general public users, you can set up a preference such as, if a call is coming in from the Caller ID associated with a specific person (MOM), send it to my cell phone. Otherwise, send it to voice mail. Another example is if a call comes in prior to 5 pm, send it to my work phone or have it record a message and send that message to my email. Another example is, if an email is from my boss, call me immediately and read it in text to speech. This can allow users a control protocol to handle their communications. As a further example, a user can have a cell phone that no one knows their number. They can also have a second number that they tell people and have forwarded to their original number. If they are getting too many calls and want to change their publicly known number, they can without changing their real cell phone number. Also, information associated to the operation of any given user device and information related to the entered and/or non-entered activities of users can be monitored. Entered user activities may include, for instance, information the user inputs into the system, i.e., keystrokes, cursor movements, and the like. Additionally, non-entered user activities may include activities such as the user's body movements and expressions that the user does not input, but that can be captured or observed by the user's device.

A monitoring engine 80 may function in any manner that allows either an operator of the system or a third party to perform the desired monitoring. For example, a monitoring engine may gather and relay user data by running continuous built-in tests (“CBIT”) and transparently monitoring without disabling a user device or ending software applications. In another example, the monitoring engine may gather information or allow a third party to monitor a user device by taking screen shots, interrogating the system and sub-systems, and receiving information from sensors, the CPU, input and output devices, and/or the like. In yet another example, the monitoring engine can be used to monitor the health of the system, including for CPU utilization, low remaining disk space, low memory, etc. As described herein, this monitoring action can be integrated with other parts of the system to allow administrators real time access to their systems. For example, if a user's computer/server is running low on memory, an alert can be sent to the platform which can then notify an administrator and ask questions like, “Would you like to run a diagnostic test?” If the answer is “yes”, the platform can run the test and give the results to the administrator. Upon delivering the results, the platform can ask the administrator what actions could be taken on behalf of the user, i.e., the platform could ask “Would you like me to reboot, fail-over to the backup servers, or do nothing for now?” If the administrator responded with a certain option, the platform could then take the desired action.

The platform 10 can also contain a configuration engine 85 as shown in FIG. 1. The configuration engine allows the operator of the platform to design and develop software application templates, containing an application and a template. The configuration engine contains audit capabilities for storing “static” applications and recipient interactions. For example, with outbound phone call, the configuration engine can use a network of local (relative to the user) phone numbers and/or caller IDs in the communication method. As another example, the configuration engine has the ability for on-hold management which allows a user to be placed on hold until either an agent or the speech engine picks up, or a predefined limit (say 10 minutes) is incurred. Also, it can configure hours of operation for a particular user's agents.

The platform 10 can be connected to the network 25 through an interface 30 that allows the platform to interact with the various user devices and the different communication methods they use. The interface 30 accordingly comprises any known phone interface like Session Initiation Protocol (SIP), Simple Object Access Protocol (SOAP), Skype, and VOIP. The interface also contains an email interface (like Microsoft Exchange or SendMail), an IM interface (like Skype, Yahoo Instant Messenger, Twitter, Jabber), and web interfaces like a “screen pop.”

With such components, the platform 10 can be used to receive data and information from the user device (or system) 15 via sources such as the network server, conference server, ftp server, and/or the email server. As well, the platform 10 can send data and information to the user devices 15 via mechanisms such as the web server, ftp server, network server, the email server, and/or phone. As well, the platform can send or receive data by mechanisms like API integration and voice mechanisms like phones, VOIP, and answering machines.

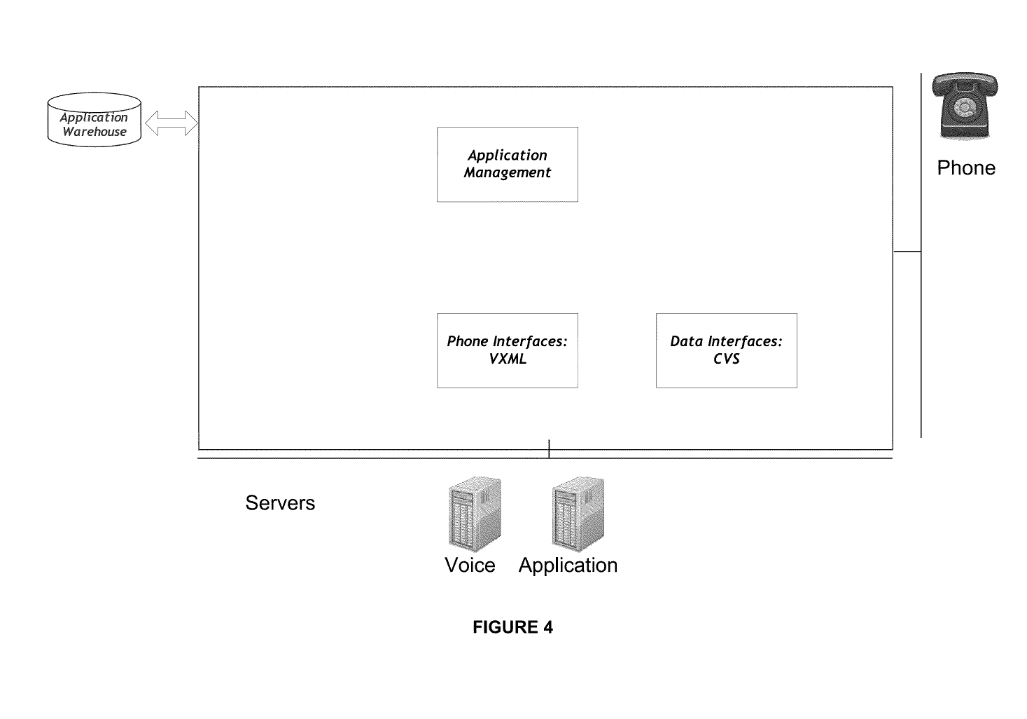

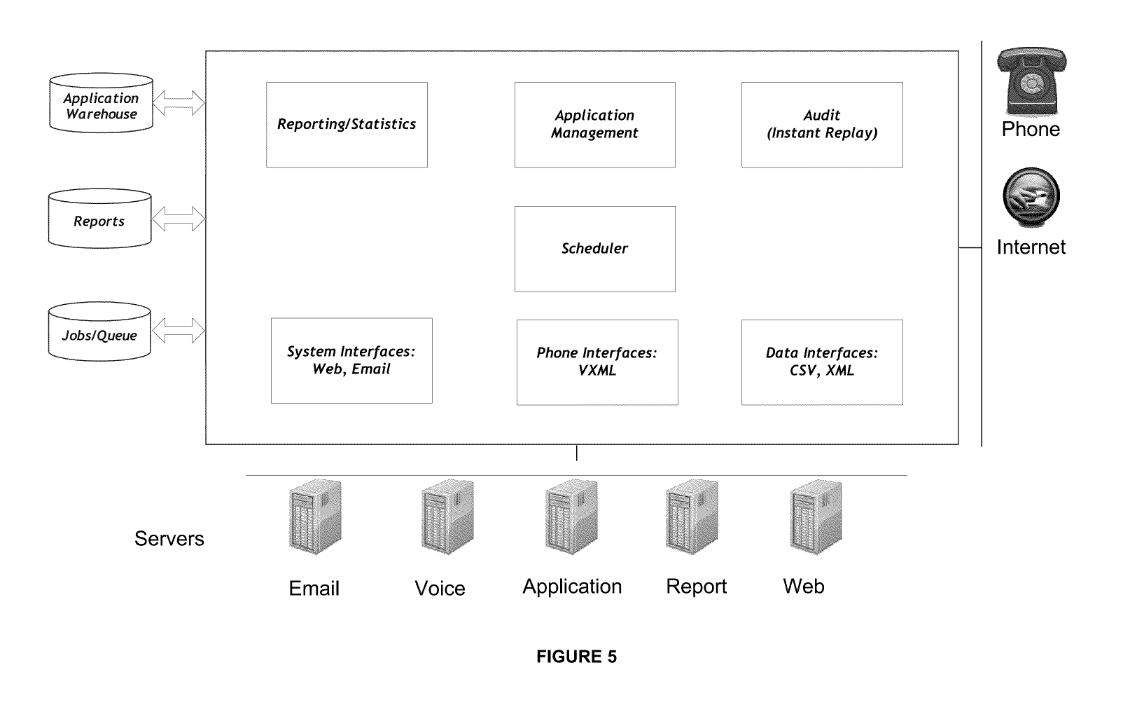

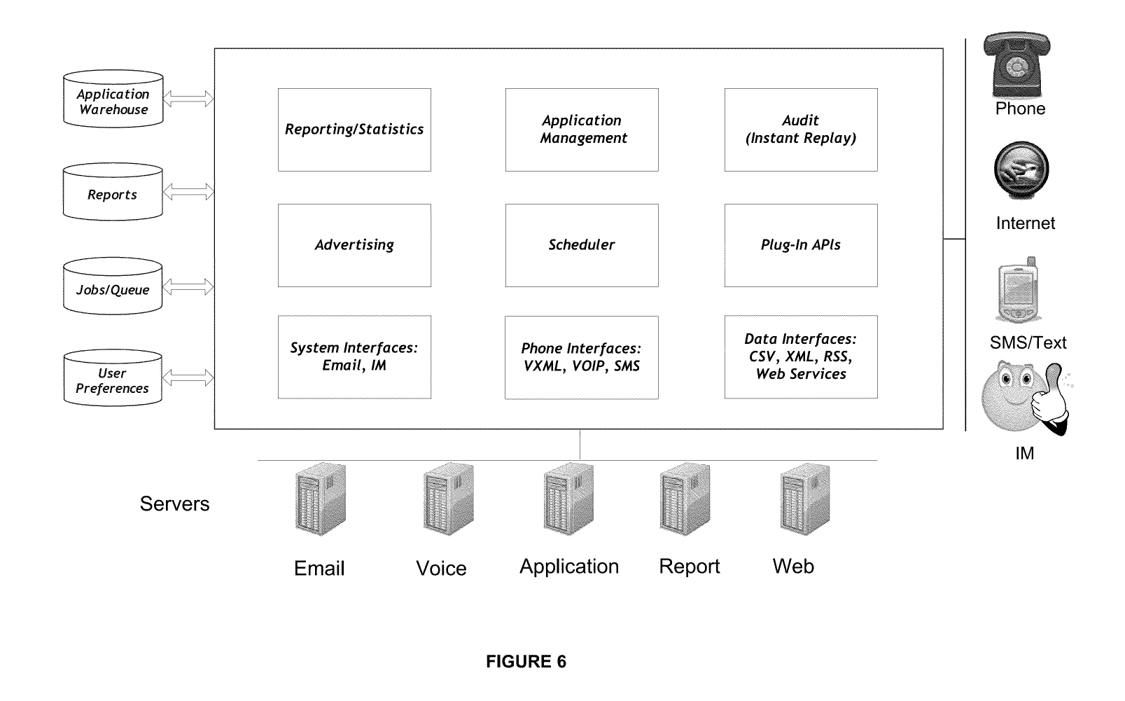

The platform can be customized for different categories of users. In some embodiments, the system can be configured as shown in FIG. 4 for minimal involvement by the user. In these embodiments, the platform has been configured to be operated as a managed service for the user so minimal components (and associated functions) of the platform are present. In other embodiments, the system can be configured as shown in FIG. 5 for more involvement by the user relative to the configuration FIG. 4. In the embodiments shown in FIG. 5, the platform has been configured to be operated as a semi-managed service for the user so that a moderate amount of the components (and associated functions) of the platform 10 are present. In yet other embodiments, the system can be configured as shown in FIG. 6 for maximum involvement by the user. In these embodiments, the platform has been configured to be operated as a self service for the user so the maximum number of components (and associated functions) of the platform are present.

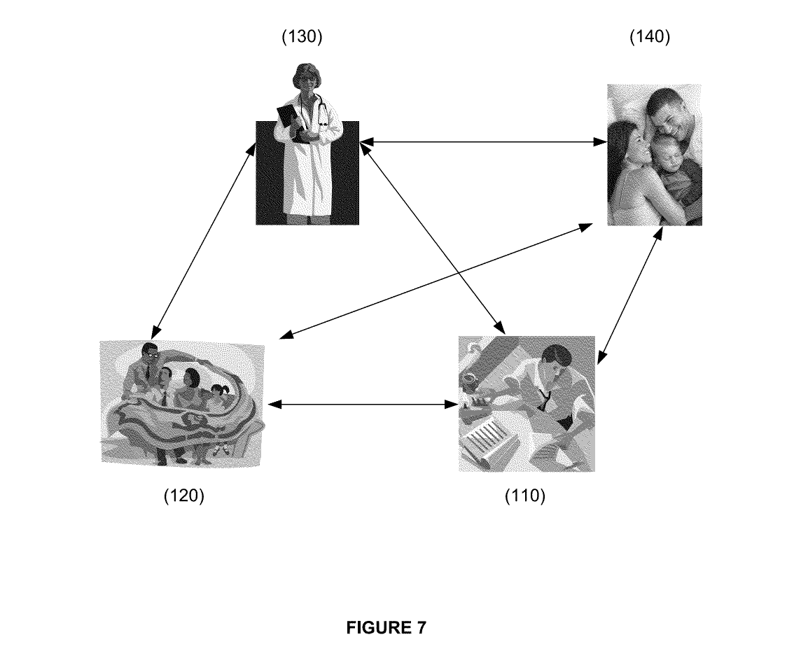

The platform 10 can also increase the efficiency of communications between two or more users that use different devices or systems or that prefer different methods of communication. In many industries, especially the health care industry, there are multiple users that need to repeatedly and effectively communicate with each other. Examples of the users in the health care industry include insurance companies, medical offices, billing companies, collection agencies, and patients, as well as the customers and partners of these users. An example of the users in the health care industry can be illustrated by referring to FIG. 7. In this Figure, a first user (medical biller 110) needs to communicate about an unpaid claim with a second user (an insurance company 120). The platform 10 can be used to monitor the claim status via the insurance company's web services. If needed, the platform 10 can be configured using any payment parameter (including length of time before payment, amount of payment, agent availability [including when the biller agent is available and if they are available, he can start agent related transactions like phone calls], insurer [since some billers might call different insurance companies on different days]) so that when that parameter is met, the platform 10 can place an outbound telephone call on behalf of a third user (doctor's office 130) to the insurance company. The platform could then navigate the insurance company's system (using IVR) and then wait on hold until an agent from the insurance company is ready to be engaged. At that time, the platform 10 can provide synchronized screen pops to both the insurance company agent as well as the provider agent, giving both agents the information they need to look the claim up in their respective systems. If needed, while both agents are on the phone, the platform 10 could then contact either the doctor's office (i.e., to verify the services rendered) and/or the patient 140 (as a fourth user) to verify the payments already made. Once both agents are ready, they can either talk to each other via any desired communication channel (i.e., phone, voip, IM chat, etc.) in order to bring the claim to resolution.

In other words, the platform can coordinate the communication mode of the various users participating in the communication. In some embodiments, the modes can be coordinated by integrating the communication with the existing software that each user employs. As an example of these embodiments, a claim for payment for a doctor's services (a first user) is overdue from various patients (the other users) for many days. In such an instance, the platform 10 can interact with the software operating on the doctor's office network to determine which claims are overdue by 30 days (or 60, 90, or any other time period). The platform 10 can then try and contact the various patients by their chosen communication channel (i.e., email, telephone, etc.) to remind them of the payment due.

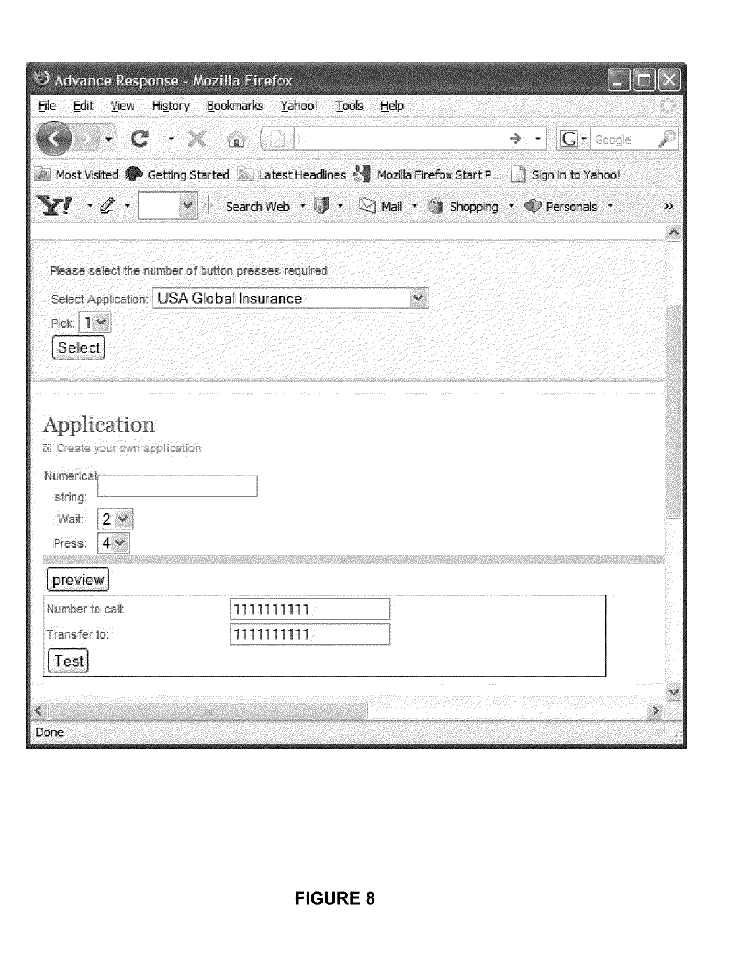

In other embodiments, the communication modes can be coordinated between users by automated phone calls from the platform 10. In these embodiments, a first user can configuration the platform 10 to call a second user and navigate through the second user's system using IVR. Once the first user has automatically navigated through the second user's system to reach the desired part of that system, the platform 10 can be instructed to wait “on hold” until a desired point in time is reached. One point in time can be, for example, when the second user's agent starts to engage in the communication process, at which time the interactions between the first user and the second user can begin. An example of this coordination can be seen in the user interface depicted in FIG. 8. In FIG. 8, an initiating company (first user) can use the platform 10 to make an automated (or partially assisted) telephone call to a company called USA Global Insurance (the second user). When the call is made to USA Global Insurance's IVR, it can wait for that IVR to answer. Once it answers, the platform 10 can navigate Global Insurance's IVR. For instance, it can be instructed to wait the desired time period (i.e., 2 seconds) or listen for a specific phrase like “for claims, press 4”, and then press the number 4 which will choose the desired option (i.e., go to the correct queue to wait to speak to a live claims person). Subsequently, it will automatically wait on hold until the recipient agent (of the second user) engages in the communication by answering the telephone.

When these entities communicate with each other, absent the platform there are numerous inefficiencies because their preferred communication method may differ from each other. For example, a patient may prefer to communicate about an invoice using a wireless telephone whereas a doctor's office may instead prefer email communication. As well, there exist inefficiencies because their preferred communication device/system may differ from each other. For example, an insurance company may prefer to communicate about an invoice using a computing device operating a first billing software (like AllScripts or a customized billing system) whereas a doctor's office may instead use a second billing software (like Lytec).

These problems have traditionally been addressed using many different solutions. One solution has been to hire more personnel (i.e., agents) to handle the increased loads from the inefficient communication. Another solution has been to implement either a dialer (for outbound) or an IVR device for inbound (call center) calls. Yet another solution has been the increased use of internet-based services for claims-based communications. But none of these solutions have solved this communication inefficiency because there's currently not a solution that allows both companies to either automate or semi-automate their work while using their internal systems to process the insurance claims.

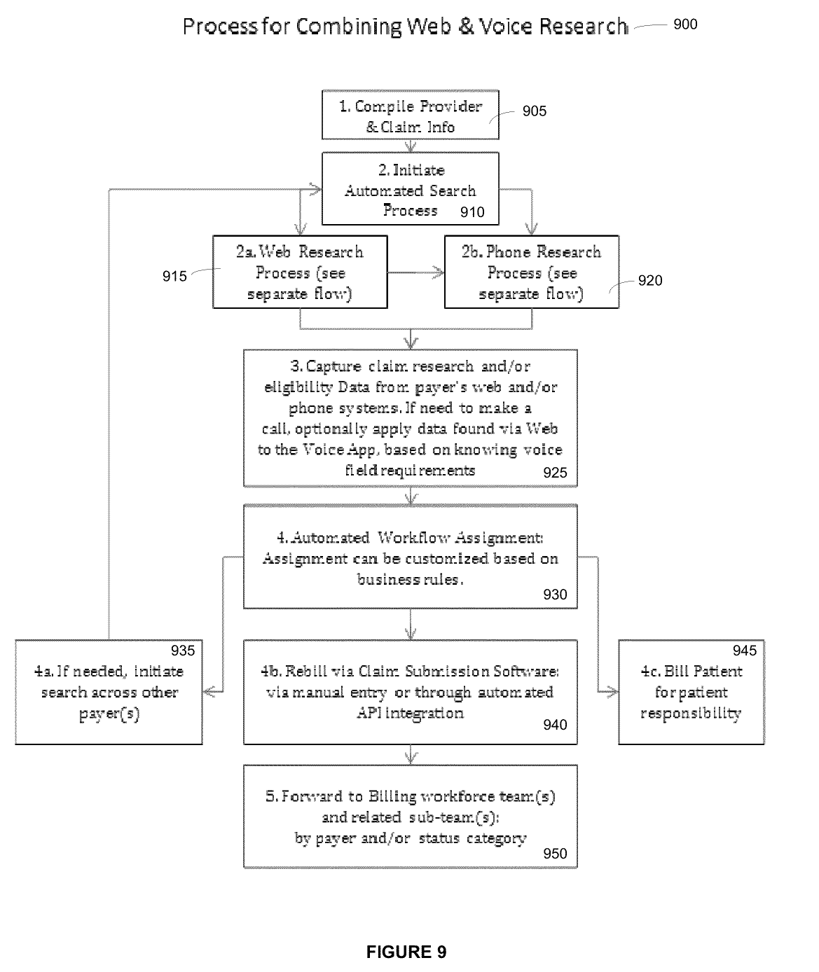

Accordingly, in some embodiments the systems and methods described herein can be used for automating medical insurance claims and eligibility research. In these embodiments, the process can combine both web resources and telephone resources. One example of these methods is illustrated in FIG. 9. As shown in FIG. 9, the process 900 can compile claim information from multiple payers and/or multiple channels. The process 900 begins in box 905 when the claim and/or patient information is compiled from users, in particular provider claim information systems. The information or data can be compiled using any of the following methods. First, the data can be manually entered into the system interface. Second, the data can be exported from another claim management system, converted to a desired table format (such as .csv), and then imported/uploaded into the system. Third, the information can be automatically imported and/or uploaded into the system via API (application programming interface) integration to another system. The API may comprise a URL-based API, where the account information and/or claim parameters are passed via designated fields in the URL.

Next, as shown in box, 910, the system initiates an automated search process through web portal(s) and/or voice dialing system(s). The desired information can be searched by a web research process, as shown in box 915, and/or a phone research process, as shown in box 920. The web search process involves going to a web portal URL and interactively and automatically entering the claim information into search fields, including alternate and/or recursive search parameters, as described in detail herein. Both insurance payer web portals and other aggregated insurance portals (such as NaviNet, Availity, MevsNet, and others) can be searched alone and/or in concert with other portals. For instance, one portal may indicate that there are two or more insurance companies involved and provide contact information about the second, third, etc insurance companies. The system can take this data as input and automatically launch additional research processes for each entity identified. The desired information can also be searched through phone systems by using the system to dial a desired phone number, and interactively submitting provider and claim information through DTMF (Dual-tone multi-frequency signals, more commonly known as a telephone's physical or virtual keypad entry) and/or speech recognition, to then retrieving the resulting detailed claim information. Both insurance payer phone systems and other phone systems (e.g., third-party aggregators) can be searched. Similar to web portals, phone system processes can be initiated as stand-alone actions and/or be initiated in concert with other phone systems. Further, web and phone systems can be coordinated with each other. For instance, a web portal may indicate that there is a second insurance company and may provide the phone number for the second insurance company. The system can take that web input and subsequently launch an automated phone process to the phone number given by the original insurance company's web site.

Next, as shown in box 925, the system captures and compiles claim research and/or eligibility data from payer's web and/or phone systems. Optionally using an iterative process, if the system determines that a phone call needs to be made to compile additional information not found on the web portal, the data can be found during web-based research can be used as inputs into the interactive voice application(s). The information can be input based on knowing field, or slot, requirements in the respective interactive voice response (IVR) applications and obtaining the data required for input from the web. Similarly, web slot/field requirements can be obtained from the payer's IVR and/or fax services and entered into the web portal(s). Finally, required data can stay within the same mechanism. For instance, web eligibility information may be retrieved from the payer's web portal. In a more detailed example, consider a scenario where a provider's system sends claim research information. When performing the full research surrounding the claim, eligibility, benefit, deductable, co-insurance, co-pay, etc research is performed. In this example, let's say that the provider does not supply all of the information needed to conduct the full search. The system can start with the claim search and obtain information from the successful claim search in order to fill the slot/field requirements for the subsequent searches related to eligibility, benefits, etc.

Next, as shown in box 930, a workflow is assigned. Based on the information returned from the web portal(s) and/or phone system(s), the system will apply business rules to determine required next steps and/or designate a workflow category for assignment. For example, one result is that if the claim is not found on a payer's web site, but where another payer is designated, then the automated research process may be required on another payer website, such as a subsidiary site. In this case, the system will return to initiate the automated search process in the other payer website(s), as shown in box 935. The system can also designate that in an event where there is no record of claim receipt, but confirms that the patient is eligible for benefits/coverage on that date of service, then the claim can be classified for re-submission (“re-billed”) to the insurance company, as shown in box 940. The claim can be manually re-billed through normal agent processes. And if the system is integrated with other software and/or systems, such as a claims management software or workflow management software, then the claim can be auto-re-billed without manual intervention. During this process, if the insurance payer has paid their contracted amount(s), then the system may designate that any remaining balance may be billed to the patient, as shown in box 945, or responsible subscriber/member.

Next, as shown in box 950, if a claim is found to be denied and requires manual updating, the system can assign a category for routing to an appropriate workforce team and/or sub-team for agent follow-up. As one example, the workforce may be organized according to insurance payer. As another example, the teams may be organized by claim status categories.

The outcome of the automated research process 900 can also be used to help predict next steps. For example, based on a denial reason code, the automated system could predict and populate the right question for the biller to ask the payer agent. In another example, a suggestion could be given through the user interface to the biller regarding a likely path to resolve the outstanding claim. In yet another example, it could be used for the payer/provider data analysis and predictive nature of the system. Often, the system receives uploaded files with hand typed in doctors or NPIs (National Provider Identifier). In payer web sites (such as United Healthcare), a user must first pick the right Tax Identification value before picking the specific NPI, facility name, or doctor name. Since the system is on the payer's web site, it can get all of the NPI's/names associated with the Tax identification value. When the provider sends random names/NPIs, the system can create fuzzy (or exact) logic to automatically predict and make the associates the Tax Identification value that would normally he done during setup.

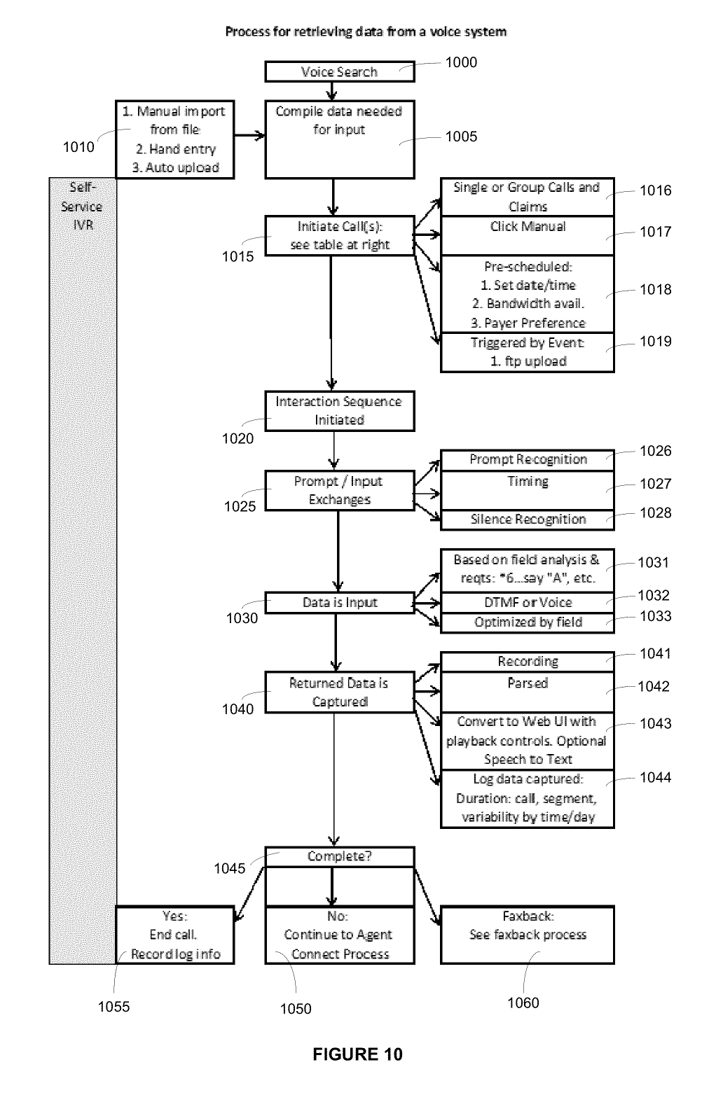

Some embodiments of a phone research process 920 for automating claim research via an interactive application over a voice system is depicted in FIG. 10. FIG. 10 illustrates a process 1000 for voice searching which can be used to interactively compile data from a phone system. As shown in FIG. 10, the process begins when claim and/or patient information is compiled from provider claim information systems, as shown in box 1005. The claim information can be manually selected or entered into the system interface, as shown in box 1010. The claim and patient account information can be selected from the system UI (user interface). An option to place a call can be selected. Also, an optional question can be typed into the interface to be associated with the account for which a call will be made. The question can ultimately be relayed to a payer agent if the call progresses to that stage. The question can be viewed by the payer agent on their system. The claim and/or patient information can also be exported from another claim management system, converted to a desired table format (such as .csv) and then imported/uploaded into the system. The claim and/or patient information can also be automatically imported/uploaded into the system via API integration to another system, such as by a URL-based API, where information can be passed and received via respective fields within the URL.

The process 1000 continues as shown in box 1015 when calls are initiated by the system to designated phone numbers for insurance payers and/or third-party data aggregators; (e.g., clearinghouses). The calls can be launched individually or in parallel groups, related to single claims and/or groups of claims, as shown in box 1016. The calls could also be launched manually, such as by selecting a ‘button’ in the software interface, as shown in box 1017. For example, a “connect to payer agent” button could exist in a 3^{rd} party practice management or workflow management system. In this example, pressing the button would initiate a call that could follow the same research path as well as stay on the line to speak with a payer representative. The calls could also be launched based on a scheduler using a set date(s) and time(s), based on when necessary bandwidth is available to minimize latency, and/or based on payer preferences, as shown in box 1018. The calls could be launch based on an event, as shown in box 1019. For example, the event could occur when a new account or claim file is detected in a secure ftp site/folder.

After the calls are initiated, a predefined interaction sequence is initiated, as shown in box 1020. In some configurations, the sequence could be based on previously mapping the various payer IVR phone applications. The input fields can be defined according to type of data field. As well, any allowable method of input (e.g., DTMF and/or Speech) can be used.

Next, as shown in box 1025, the system can interactively navigate the IVR application. The inputs can be triggered in response to one of the following events or logic states. First, as shown in box 1026, the prompt meaning and/or duration is understood via speech recognition. Second, as shown in box 1027, timing sequences can be used to determine when an input can be entered; e.g., 4 seconds after the previous entry (DTMF or audio), or, 3 seconds after the end of playing a prompt audio. And third, silence recognition is used to determine a decision path and trigger a system entry.

In a counterintuitive approach that is not used in some conventional systems, the system does not have to rely on utilizing voice recognition and grammars to identify where the IVR is in the call path, and, sub sequentially, what action to take when. The system can determine IVR path location by detecting the duration of silence following an IVR prompt. In this case, the detected silence is used as the method of determining what and when to enter the requested information. In other words, the decision making processes that determines the path to take can be chosen by specified silence recognition. Given a decision point where the automated system or caller needs to input some sort of verbal or DTMF response, at that particular decision point during the call flow, there will be a silence of a specified length from the payer's IVR. That specific silence could be 2, 3, or more seconds of silence depending on each decision point in each payer's system. Mapping the specific silence at the respective decision point(s) to different paths/actions to take avoids possible re-coding issues that can arise when potential changes in prompt wording occurs from time to time in the IVRs. This effectively keeps the IVR decision point location anchor point fixed to the input being requested even if some of the IVR wording changes, ultimately maximizing compatibility with the automated search system. For example, if there is a particular decision point in a payer's IVR, (for our example, we'll say that it's the first decision point) and the specific “seconds of silence” at that decision point is 3.0, then the automated system would be coded in a way that if 3 seconds of silence were recognized at that decision making juncture, the system would identify the silence as a time to take action and take the next proper action. Similarly, let's say there are severe weather conditions at the insurance company's call center. An opening prompt is added saying “Due to severe weather conditions, hold times may be longer than usual.” Since the system would be using silence as the indicator of when to take action, the system logic would automatically account for the new prompt and simply take action when the silence is detected, a little later than normal.

An IVR's recorded prompts have specific file size ranges. These values can also be used to determine call path location, decision points, and/or actions to take next. Rather than using voice recognition, utilizing specific file size ranges can be utilized to indicate what the payer IVR is “saying” and thus what action should be taken. In this way, the system can know when to respond in order to get details, or go to the next claim, or when the payer IVR has completed playing all the claim information, even if it's not directly known how many claims were found. The recorded file sizes can also be used throughout the navigation of the payer's IVR to help determine where the application is in the call path, or what the payer IVR is requesting. For example, this could let the system know if it's out of sync, and help calibrate to get back in sync with the payer IVR, similar in concept to a virtual GPS navigator for IVR applications. It can also be used to determine if input at a specific location in the IVR needs to be re-entered or if the information needed at the next location can be entered.

The process 1000 continues, as shown in box 1030, when data is automatically entered by the system into the payer IVR application. The specific data formats are defined based on field input analysis and requirements, as shown in box 1031. For example, one IVR field could require a string of 8 numbers. Another example may require the entry to be preceded by a “*” and/or followed by a “#” sign. Yet another example may allow an entry to be spoken: “ABCDE”. The data could be entered via DTMF and/or speech, and the live progress of the call tracked as noted in box 1032. The data entry can be optimized by field, as shown in box 1033. For example, in a sequence of entries, one entry could be via DTMF, and the next entry via ‘speech.’ As well, the timing can be optimized to maximize IVR recognition success and/or minimize the call duration. In another embodiment, the live progress of the call can be displayed and/or returned to the billing agent (first party). In this manner, the billing agent will know what the system is doing, for instance “entering NPI”, as well as when they will be connected, for instance, “connecting you now”.

The process 1000 continues when the either returned data (prompt segment(s)) is captured by the automated system, as shown in box 1040, or the payer agent/hold queue is connected. The returned prompt(s) or system to system or person to person conversations may be recorded by the automated system and may be associated with the call and/or any identifying information, for instance, account number, unique identifier, agent identifier, phone number called, etc, for future searching and correlation analysis as shown in box 1041. The recording(s) themselves could be in various known file formats, such as a .wav file, .mp3 file, etc. As noted in box 1042, the prompt audio file(s) can then be collected and/or parsed into desired segments through one or more of the following processes. First, the segments are based on specific claim and/or eligibility information. Second, the segments are parsed through a voice driven algorithm. For example, the system can listen for the phrase, “we found 6 claims”. By recognizing the “6”, the system knows how many times to loop capturing groups of claim information sets. In another example related to claims summary and detail, the system goes through 6 loops of recording the claim summary information only, and then the claim detail information only. These respective pairs are segmented and would be associated with each other as well as the overall account being looked up.

The parsed prompt audio file segments are captured and then made available to listen via a web page user interface (UI), as shown in box 1043. The UI could allow a user to control playback of the audio file. The controls could include standard buttons for play, such as rewind, fast-forward, stop, and pause. As well, a slider bar could be used to select or move the position of the point in the audio file for playback. Optionally, the audio file could be processed via a speech-to-text engine as shown in box 1043. The resulting text could be populated to a desired field in the database. The content of the database field could then be rendered via the UI template and/or in a field in a return file and/or accessed by an API for inclusion into another system UI. Moving to box 1044, the log data is captured about the call prompts. The log data could include, but not be limited to, attributes such as duration, call date/time, segment length. Other meta-data could be captured related to variability of duration according to time-of-day or day-of-week.

The process 1000 continues when the system determines if the requisite data has been collected sufficient to understand the claim details necessary for resolution, as seen in box 1045. If so, then the call can be completed and the system can hang up as noted ion box 1055. The log information can then be recorded.

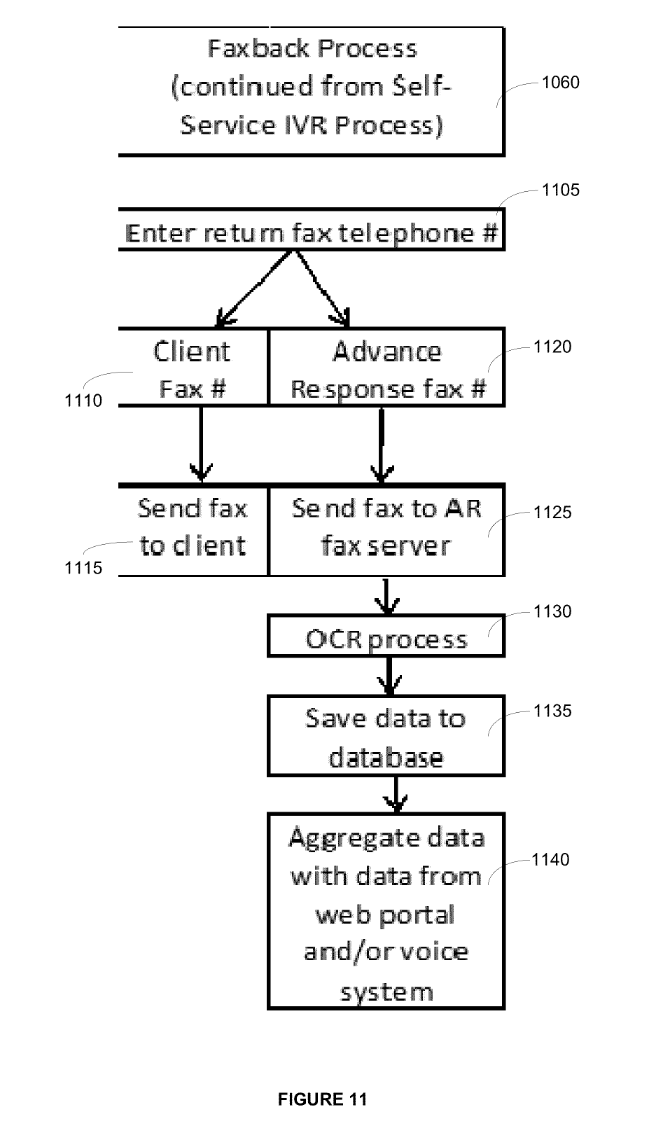

If not, and further information is required, it can be obtained through an available fax-back service as noted in box 1060. The following process illustrated in FIG. 11 can be used to request that information. At the appropriate prompt to enter a desired fax number, the automated system can enter and/or speak the desired fax number as shown in box 1105. The fax number could be entered by the automated system that may be associated with the billing agent or entity, as shown in box 1110. In that case, the faxback service would fax the requested claim information to the billing agent as shown in box 1115. Alternatively, the fax number could be for the automated system as noted in box 1120. In that case, the faxback service would fax the requested claim information to the automated system fax server, as shown in box 1125. Upon receipt to the fax server, an optional optical character recognition (OCR) process could scan the fax information and parse out the respective fields for entry into the database, as shown in box 1130. The data (including the account, payer, and provider) is then saved to the database and the faxed data could then be aggregated with any other related information pertinent to the claim, such as may have been gathered via web and/or self-service voice applications, as shown in boxes 1135 and 1140.

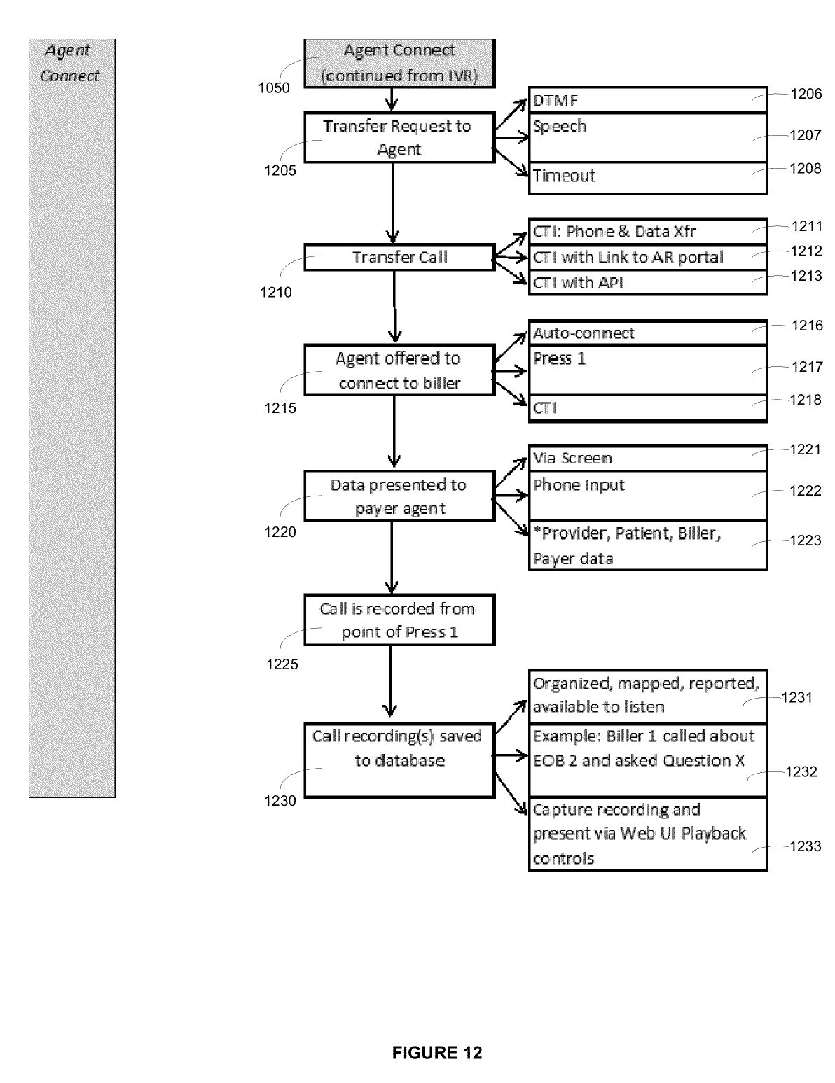

If the requisite data sufficient to understand the claim, eligibility, etc details necessary for resolution has not been collected, then the system can automatically select an option to transfer the call to speak with an agent, as shown in box 1050 in FIG. 10. The details of this process are depicted in FIG. 12. The process 1050 begins when a transfer request is made via DTMF at the right option, as shown in box 1206. The transfer request can also be via speech input, if allowed, as shown box 1207. This can occur, for example, by requesting “agent” or “representative” or other allowed spoken input. The transfer request can also defaults is there is no input, as shown in box 1208.

Upon a successful transfer request, the system can provide information to the transferred agent as shown in box 1210. The data and information transfer can be made using any of the following methods. First, by computer-telephony interface (CTI) via phone and data transfer, as shown in box 1211. Second, by CTI with a corresponding link to the automated system portal, as shown in box 1212. In this case, the biller question can be shown to the payer agent, to give them the reason for the call, even prior to connecting with the biller. Third, by CTI with API, enabling direct integration/link to the automated system, as shown in box 1213. In this case, the biller question can be shown to the payer agent, to give them the reason for the call, even prior to connecting with the biller. During this process, the data and information content can be shown on the agent screen or can be “spoken” through the agent phone, a process which is commonly called whisper transfer since the claim ID can be spoken to the agent immediately prior to connection. The data could comprise information such as provider tax ID, patient account number, biller name or ID, and payer data obtained in the self-service IVR and/or from the payer's web portal along with the question/issue about each claim.

The process 1050 continues in box 1215 when after being transferred to the agent, the system can enable the agent to connect with the biller. This connection can auto-connect the agent to the medical biller whose claim is being presented, as shown in box 1216. As well, the connection can also offer an option to the agent to connected to the biller, i.e., by “press 1 to be connected to the biller” as shown in box 1217. Further, the connection can be made by leveraging the CTI to facilitate the connection to the biller. This allows the transferred agent the time necessary to prepare for the discussion, including the possibility of reading a biller's question, looking up information in their system, and/or asking supervisors for help, all prior to connection and not requiring the billing agent to sit on hold. Thus, transferred agent readiness hold management is enabled.

The process 1050 continues as box 1220 when the data is presented to the payer agent. The data can be presented the payer agent via a screen or by using a phone input, as shown in boxes 1221 and 1222. The data presented can include any information about the provider, any information about the about the patient, claim and/or eligibility, benefit, plan, or payment information such as check/payment number deductible, co-pay, co-insurance, as well as any information about biller, and any information about the payer, as shown in box 1223. The automated system can then record the call between the payer agent and the biller, as shown in box 1225. This process can be initiated, for example, at the point when the payer agent presses 1 or CTI indicates the reception of the call by the payer agent.

The process 1050 then saves the call recording to a database, as shown in box 1230. The call recording is mapped to the research data and made available to be listened to by a biller, as depicted in box 1231. The reporting can be generated to include any call log information, including the call duration, time of day, etc. For example, the reporting can include the situation where biller 1 called about EOB 2 and asked question X, as shown in box 1232. The recorded audio file can be presented via web UI, as shown in box 1233. This could involve playback controls include play, rewind, stop (pause), fast forward, as well as a slider bar that can be used to position the point of playback where desired.

During the process 1050, log files will be generated during the course of the call that can track the log events. Analytics and reports can then be generated from the log events and used.

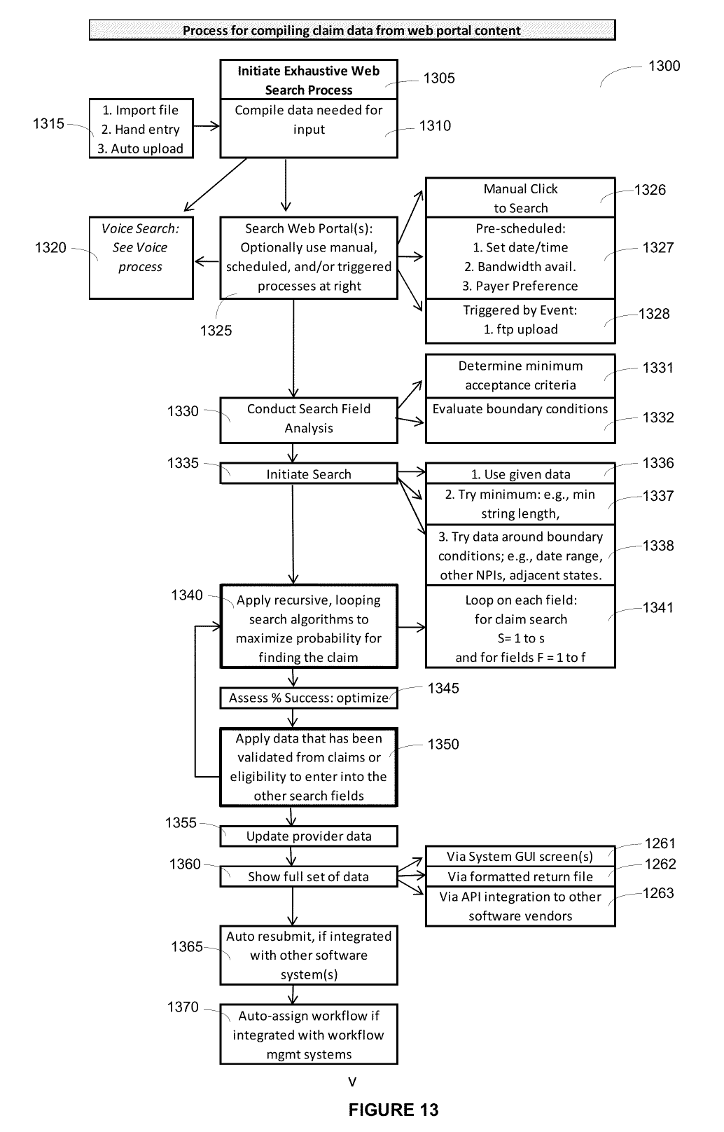

Returning to FIG. 9, the process 900 included the web research process shown in box 915. Some embodiments of this process are illustrated in FIG. 13 by process 1300 which compiles claim data from web portal content. The process 1300 begins in box 1305 by initiating an exhaustive web search process for claim, eligibility, benefits, deductable, (pre)authorization, co-insurance, co-pay, check/payment information and/or other patient information. The resulting information can also be compiled with data from provider claim information systems, as shown in box 1310. The claim information can be manually selected or entered into the system interface by the methods shown in box 1315: the claim and patient account information can be imported in a file from another claim management system; the claim and/or account information could be entered manually; and/or an automated upload could be used. As depicted in FIG. 1320, a voice search process as described herein could be initiated to collect the claim data.

The process 1300 continues at box 1325 when the web portal(s) is searched. In this process, the system is initiated to automatically search for one or more web portal(s). A user selection in the system can be used to initiate the upload process, as shown in box 1326. Or the upload can occur per a schedule, such as during a set or recurring date and time, such as when bandwidth is highest/latency is lowest, or it can be set according to payer preference, as noted in box 1327. Or the upload process can be triggered by an event, as shown in box 1328, including an API request or an upload on a schedule pursuant to payer(s) preference Upload into the automated system triggered by an event; e.g., ftp file upload.

The process 1300 continues at box 1330 by conducting a search field analysis. In this process, the minimum acceptance criteria for the search field are determined as shown in box 1331. Then, the boundary conditions for the search are determined, as show in box 1332.

The process 1300 continues when the search is initiated at box 1335. This initially can include the process of using the data that has been provided as shown in box 1336. If no claim is found, then the process can try a minimum search (e.g., a minimum string length) as shown in box 1337. If still no claim found, the process includes iteratively evaluate surrounding data around boundary conditions, such as nearby date ranges, other NPI's, adjacent states, etc., as shown in box 1338.

As needed, the process 1300 can automatically apply a recursive, iterative, looping search algorithm to maximize probability for finding the desired claim and/or eligibility, as shown in box 1340. In this process the search can recursively loop on each field, as shown in box 1341. For example, a claim search often requires the selection of the NPI of the service provider. In the case of some hospitals, there can be dozens to more than 1,000 doctors that provide services. The system can loop through the NPI list until the service provider is found. In another example, a more analytical approach can be taken. We'll use eligibility for this example. Let's say a resident of California goes on vacation to Nevada and endures a minor injury that required medical attention. When performing an eligibility check, some payer web systems require the state of residence. In this case, the state in which the procedure was performed is used first, followed by the states that share a physical border with the state where the procedure was performed. If the eligibility still isn't found, then a full/recursive search through all states may be performed.

The process 1300 then assesses the success rate, as shown in box 1345, as well as historical procedure code to NPI and/or tax identification correlations. This can include optimizing the search process; for example, to determine the greatest likelihood of success with the least number of iterations, the system can be used to analyze field data to help determine ways to optimize (reduce) timing. It may include re-ordering the process to check certain NPI's first, or re-ordering other data sets.

The process 1300 can then apply data that has been validated from claims or eligibility searches in other channels that can be applied and entered into the other search fields, as shown in box 1350. And once the information has been compiled and aggregated, data from the payer web site(s), the system will update the database with this information as shown in box 1355. The full sets of related provider and payer data will then be compiled and aggregated and shown, as illustrated in box 1360. The resulting data can be provided in a return file, including a formatted (e.g., .csv format) return file as shown in box 1362. The resulting data can be provided via an API to be displayed within another software solution, including via a URL-based API, where data information is passed via delimited fields in the URL, as shown in box 1363, or in data passed via XML or JSON. The software solution could be another claims management solution or another workflow management solution. The resulting data can be displayed in the automated system user interface, as shown in box 1361.

In some embodiments of the process 1300, any data discrepancies between provider and payer will be flagged with visual cues in the user interface. Business rules can be created to create other visual indicators. For example, color-code certain lines in the claim details page where there may be a certain procedure code. The compiled data can be sorted, filtered and searched, for example, by claim amount, status codes, and/or name.

The process 1300 continues by the denotation of an optional re-submission process, as shown in box 1365. If integration exists between the automated system and another workflow and/or claim management solution, the automated solution could designate claim categories for follow-up. For example, claims who meet certain criteria could be auto-resubmitted by 3^{rd} party system such as a claim/practice management system, workflow management system, or clearing house. As well, claims where “no claim found” status existed, but eligibility exists, could likely be resubmitted. The process can also analyze the aggregated data and provide account categorization that other systems (such as claims/practice management systems, workflow management systems, and/or clearing houses) can use to auto-assign workflow if integrated with other systems, as shown in box 1370. For example, much more detailed workflow categories could be created to help with workflow management “next steps.”

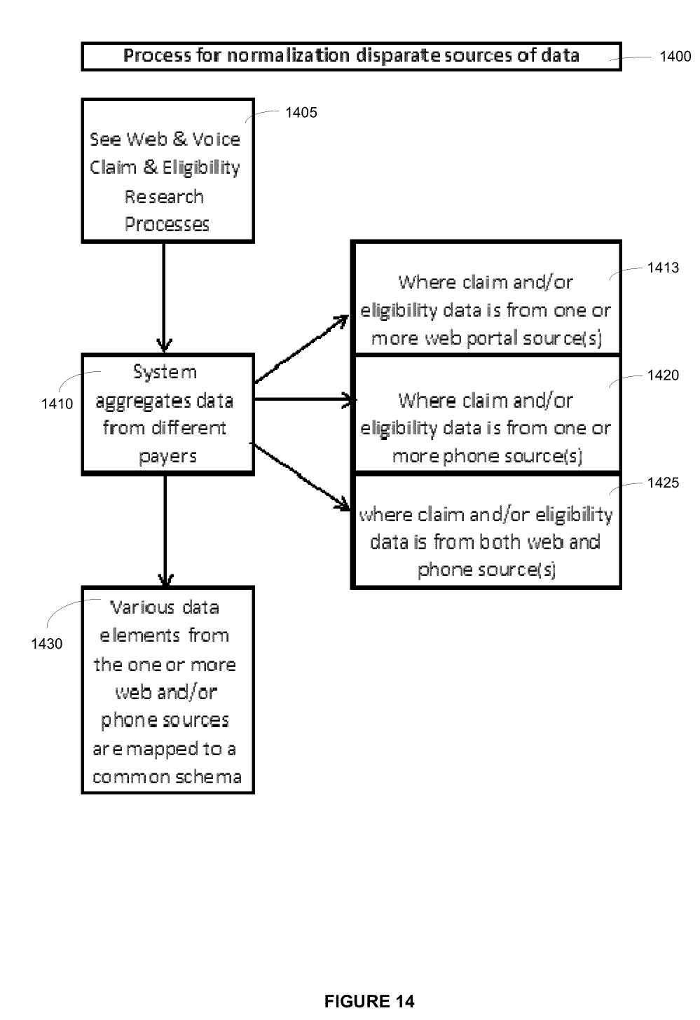

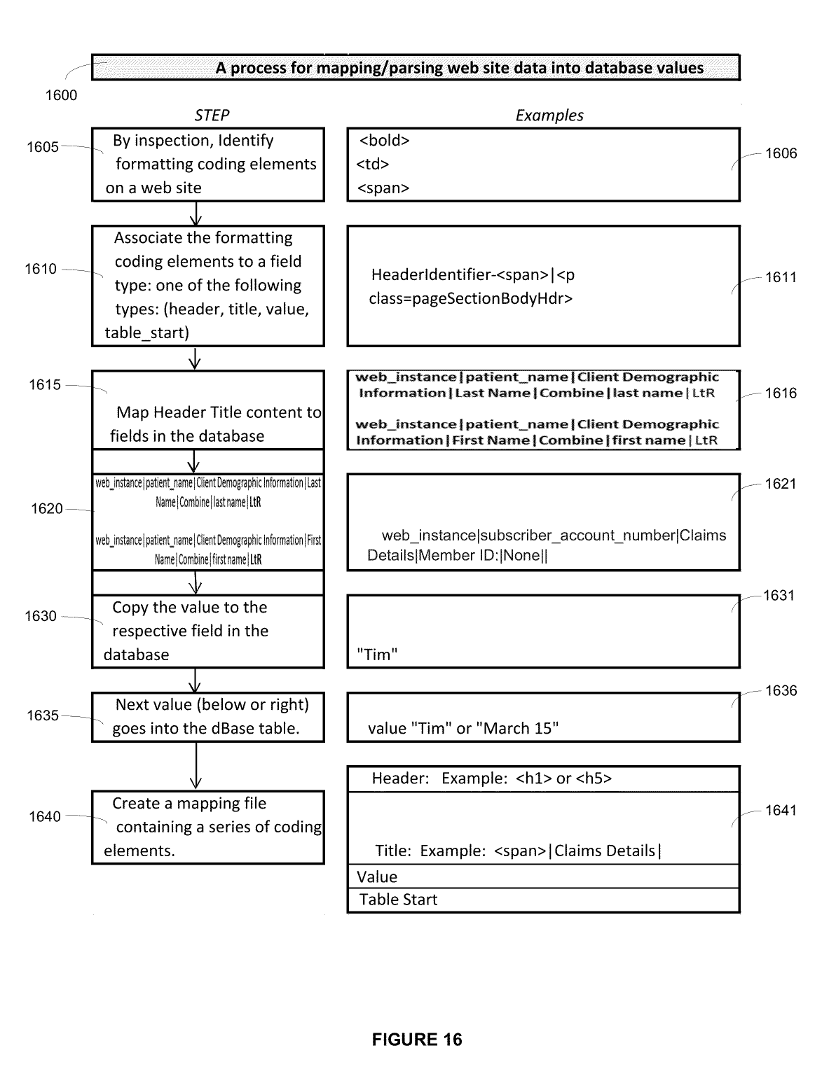

In other embodiments, the systems described herein can be used to perform a process for normalizing disparate sources of data. An example of this normalization process is illustrated in FIG. 14 as process 1400. As shown in FIG. 14, the previous methods and apparatus are used to automate the process of retrieving data from one or more web and/or voice system sites. In this process, the web research process and the voice research processes are performed, as shown in box 1405. The automated system aggregates data from multiple destinations within a specific payer's systems, across systems from different/multiple payers, provider systems, and/or direct input, as depicted in box 1410. As shown in box 1415, claim and/or eligibility research data can be aggregated from one or more web portal source(s). Claim, eligibility, benefit, plan, coverage, deductable, co-insurance, co-pay, (pre)authorization, and/or payment/check research data can aggregated from one or more phone system sources as shown in box 1420. And claim, eligibility, benefit, plan, coverage, deductable, co-insurance, co-pay, (pre)authorization, and/or payment/check research data is aggregated from both web and phone source(s), as shown in box 1425. Various data elements from the one or more web and/or phone sources are mapped to a common schema in a database, as shown in box 1430. This schema can then be used to normalize the presentation of otherwise disparate data from multiple sources. One example of this idea is described below in reference to FIG. 16.

In other embodiments, the systems described herein can be used for process that ensure compliance with desired processes for conducting web and voice medical claim research. In these embodiments, the system can be used to set forth, stipulate and ensure that users of the system follow a prescribed process for conducting automated claim research. This would enable an administrator to configure a customized set of steps and processes for optimizing research for web and phone processes, thereby maximizing claim data and eligibility return. In these embodiments, an insurance payer can define rules and/or processes that will be applied—and therefore enforced—for all users of the system. For example, the payer can stipulate that a user first perform a first search comprising a set of web research processes, and then a second search comprising a set of phone research processes. Similarly, the search order and priority can be modified for various field combinations and search combinations: for example, to review every NPI first before calling, and/or to check eligibility for all accounts before calling. Also, when calling, a user would have to follow a specific path and not able to press the “0” button to opt-out of the process. Also, it would require using a prescribed cadence for entry of DTMF and/or speech information. Another example would be to call only during certain hours, or to limit calls to a maximum of three claims at once. Another example would allow the payer to specify desired “call back times”. For instance, the payer may have reduced call volumes from 3 pm-4 pm Eastern. When the billing agent requests a call to be made, connecting the billing agent to the payer agent for one or more accounts, a choice can be given to the billing agent to either place the call now or schedule a “call back time” between 3 pm and 4:30 pm to discuss the accounts in question. Yet another example would be to show certain data attributes.

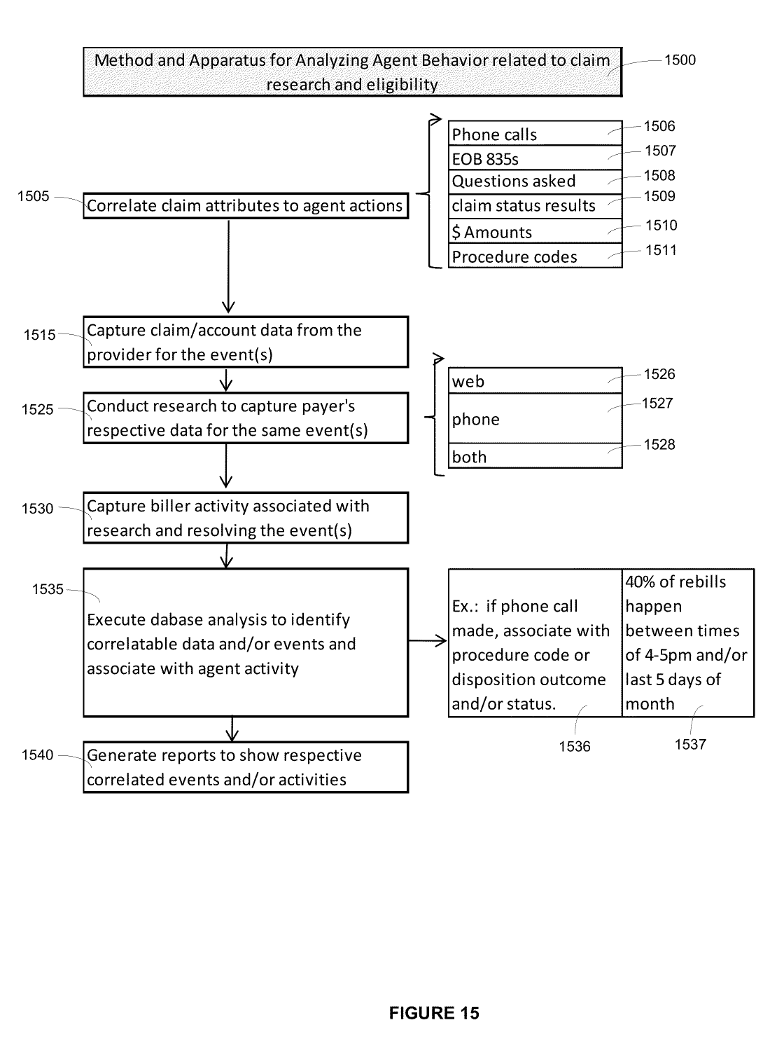

In other embodiments, the systems and methods described herein can be used to analyze agent behavior. An example of this analysis is depicted in FIG. 15 in the process 1500 that is used for analyzing agent behavior related to claim and eligibility research. Process 1500 can correlate claim attributes to agent actions, as shown in box 1505. This action could include collecting the information by phone calls, 835's (electronic remittance advice), and using questions asked to payer agents, as shown in boxes 1506, 1507, and 1508. The claim attributes claim status results, claim value (dollar amounts), and procedure codes, as shown in boxes 1509, 1510, and 1511. Utilizing this data, reports can then be created to rate and benchmark biller effectiveness and attributes across companies/entities. For instance, a specific biller in outsourcing company B may have a high success and efficiency rating of processing procedure codes 12345-12399 for United Health.

The process 1500 could then collect claim and account data from the provider for the event(s), as shown in box 1515. The process 1500 could also then conduct automated research to capture payer's respective data for the same event(s), as shown in box 1525. This action can be performed by phone system(s), web portal(s), or both web and phone portals, as shown in boxes 1526, 1527, and 1528.

The process 1500 continues by capturing biller activity associated with research and resolving the event(s), as shown in box 1530. Next, the process 1500 can execute database analysis to identify correlate-able data and/or events and associated with agent activity, as shown in box 1535. This action can include, for example, if phone call made, associate with procedure code or disposition outcome and/or status, as shown in box 1536. As another example, this action can explore the percentage of re-bills that may happen between, say, the times of 4-5 pm and/or last 5 days of month, as shown in box 1537.

The process 1500 can then generate reports to show respective correlated events and/or activities, as shown in box 1540. Reports could comprise the following categories of information. First, time-based transactions that include frequency count of web- or phone-based activity by time duration (e.g., hour, day, week, or month). Second, operational behavior, such as frequency count of activity by operational unit (e.g., individual, team, group, site, multi-site, etc.). Third, value reports with correlations to monetary value, including value of claims associated with activity (web- or phone-based inquiries), as tied to, for example, time duration, operational unit, insurance payer, provider, etc. Fourth, category reports that include reports correlated to certain data attributes associated with the member profile, eligibility and benefits, claim status, payment and/or denial reasons, and/or explanation of benefits (EOBs). These reports could comprise tabular and/or graphical presentation, such as a “pie-chart” showing a categorization of claim status attributes, or a bar-chart showing frequency or value across various claim or operational categories. And fifth, root-cause analysis reports that identify correlations to driving root causes for resulting claim status categories. For example, identifying data discrepancies in patient demographics, diagnosis and/or procedure codes, or billing information, that may cause additional research work and may also result in associated adjudication decisions by the payer.

In other embodiments, the systems and methods described herein can be used to incorporate website data into database values. An example of this incorporation is illustrated in FIG. 16 as a process 1600 for mapping and/or parsing web site data into database values. The process 1600 begins in box 1605 when by inspection, the process identifies specific coding elements used on a web site of interest. An example of this action is shown in box 1606 where a “<bold>” or “<td>” may exist. The process 1600 continues in box 1610 by associating the formatting coding elements to a field type, for example, one of the following types: header, title, value, start of a table of data, etc. In one embodiment, this can be achieved by removing/ignoring specific coding elements from the web page of interest. For example, removing/ignoring some/all JavaScript on a given web page, and leaving just the formatted data. An example of this action is shown in box 1611 where a “<span>” tag or “|” a <p class=pageSectionBodyHdr>” exists and could then be associated with the header of one or more upcoming sections of data. The process 1600 continues in box 1615 when the map the header/title content to fields in the database. An example of this action is shown in box 1616 where by identifying the presence of the most recent header and/or section title, subsequent element content/data that is found prior to processing the following header and/or title can now be associated with a specified field within a specified table. Box 1616 can be interpreted as follows, in the table “web_instance”, the field “patient_name” can be associated with data/content found after web page header “client demographic information” and web page title “last name” is found. Furthermore, in order to fill in “patient_name” properly, “last name” needs to logically be concatenated with “first name”. The “first name” will be found when the most recent web page header/title combination encountered was “client demographic information” and “first name”. The process 1600 continues in box 1620 by determining if the subsequent value on the web page is either to the right (in a left-to-right order) or below (in a top-to-bottom order). An example of this action is shown in box 1621 where the “LtR” entry denotes that the upcoming content will be presented in a “Left to Right” manner. The process 1600 continues in box 1630 by copying the value to the respective field in the database. An example of this action is shown in box 1631 where the value of “Tim” would be read and then inserted into the table/field targeted above. Next, the process 1600 considers the next value (whether it is situated below or to the right) that goes in to the database table, as shown in box 1635. An example of this action is shown in box 1636 where subsequent content (either from left to right or top to bottom) is gathered and entered into the database. The process 1600 then optionally creates a mapping file that contains a series of coding elements, as shown in box 1640 and exemplified in box 1641.

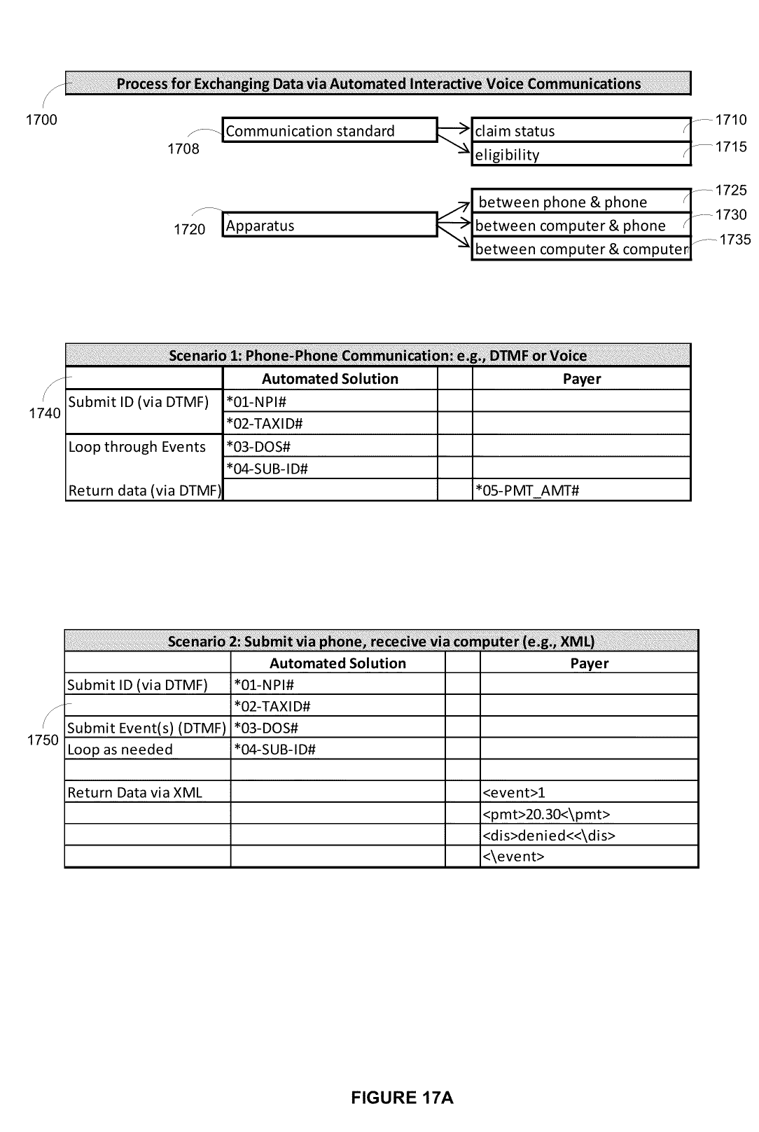

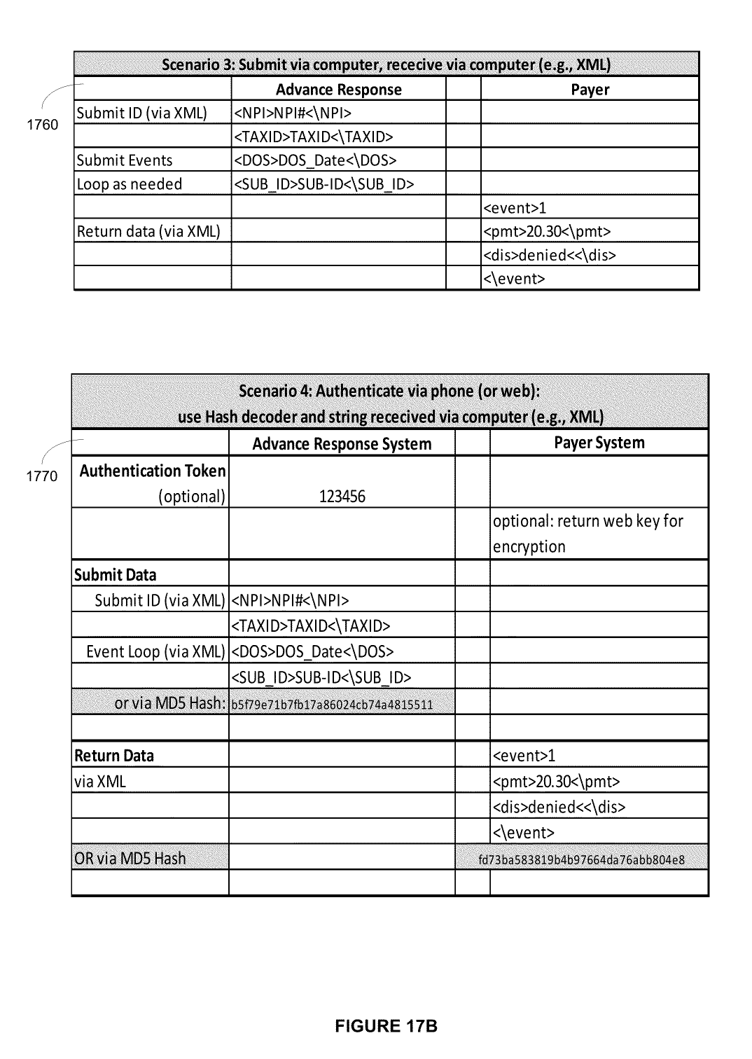

In other embodiments, the systems and methods described herein can be used to exchange automated voice data. An example of this process is illustrated in FIG. 17A by the process 1700 for exchanging data via automated, interactive voice communications. The process 1700 begins in box 1705 where a communication standard is set. The standard can be set for both the claim status and claim eligibility as well as accompanying research data such as benefit, plan, coverage, deductable, co-insurance, co-pay, coordination of benefit, payment/check, and/or (pre)authorization data, as shown in boxes 1710 and 1715. The process continues by linking the apparatus or devices that need the standard, as shown in box 1720. The linked apparatus include between phone and phone (box 1725), computer and phone (box 1730), and between computer and computer (box 1735).

The process 1700 can be exemplified in the four scenarios 1740, 1750, 1760, and 1770 illustrated in FIGS. 17A and B. In scenario 1, depicted in the example of box 1740, a standard for phone-to-phone communication is set forth and conducted using DTMF or voice (speech recognition). First the automated solution would call the Payer phone number, and when prompted, submit the required provider ID, typically an NPI and/or Tax ID. The standard would preface the content with a * key and finish with a # key. The automated system would then submit one or more claim events, such as a date of service (DOS), using the same format of a * prefix, and then DTMF content, followed by a # suffix. The payer system would then respond with a corresponding format. The “*” prefix, followed by claim status information via DTMF, such as payment amount, and then a “#” suffix. This process could be repeated for multiple claims.

In scenario 2, a proposed structure could be used between a phone and a computer, using a combination of DTMF inputs and a variety of web based formatted responses such as XML, HL7, or URL with a predefined set of parameters responses, as shown in the example of box 1750. In scenario 3, a communication standard is set forth between computer and computer, where information is both submitted and received using a variety of web based formatted responses such as XML, HL7, or URL with a predefined set of parameters, as shown in the example of box 1760.

In scenario 4, the communication leverages standards for a variety of web based formatted responses such as XML, HL7, or URL with a predefined set of parameters to communicate via phone and/or computer, but can also enhance security by using an authentication token, as well as using a cryptographic, message-digest algorithm such as MD5 or SHA-1 for passing data between two systems, as shown in the example of box 1770. In these embodiments, the automated solution first submits an authentication token to the payer. Optionally, the payer system would return a web key for encrypting subsequent data submissions. Next, the automated system would submit the necessary provider ID and claim event information via XML. Alternatively, the same information could be hashed using a cryptographic hash such as MD5, thereby enabling a much shorter data string to be entered, and containing all the information in the hash fixed length string format. In response, the payer could return data via mechanisms such as XML, HL7, or URL with a predefined set of parameters, or, in the same fashion, hashing the return data into a string.

The systems and methods described herein provide the following functionalities. First, they allow for customized/automated communication for each entity. Customized communication includes automating communication channels and paths for phone system integration/navigation/transcription, hold time management via agent opt-in, web service integration, data aggregation, data rationalization, data presentment, and EDI system integration and transcription.

Another functionality of the systems and methods described herein includes the ability to integrate with both the service provider and insurance company (payer) systems. The system can provide integration of data in and out of provider's systems (i.e. Meditech, AllScripts, Epic, McKesson, etc.). Examples of this integration include notes or status updates, re-bill identification, etc. Other examples include automatically updating a system (examples include but are not limited to: a provider's billing system or payer's web site) based on business rules. For example, a business rule can be created where if a payer's web site indicates a subscriber's policy has been cancelled, and then the provider's billing system is updated accordingly. This integration functionality can be provided via API and/or custom parsers. The formats may include: xml, csv, web-based URL, etc. This includes APIs where the systems integrate into payer or biller systems as well as APIs where payers, billing system vendors, or providers can integrate with the system. An example of where a payer would integrate with the system's API is a self service claims API. The system could publish an API indicating how the two voice/phone systems would interact with each other. For instance, the system would dial a special phone number that the payer would provide. Once the payer's system answers the phone call, they can automatically request information from AR system by entering 2 digit touch tone codes followed by the “#” key. The payer's voice system could automatically press “01” and then “#.” Per the API documentation, the system would know that the provider's NPI is requested. It would then lookup that request and automatically enter it into the payer's voice system, followed by the “#” key. In turn, the API and its accompanying documentation would indicate requests and responses from the system to the payer's system. For instance, once the payer's system has all of the search information it needs, the payer system can enter “00” followed by “#.” The system can then begin requesting information in the same way. For example, entering “44” and then pressing “#” could request the check number from which the claim was paid. The payer system would respond accordingly. The systems would keep interacting this way until all of the data is transferred. Another example of this functionality is a similar web based Application Program Interface (API) where the payer's and the systems would request and respond with the required information. For instance, an XML interface could be utilized where the system sends the payer's API credential/authentication/security information. Upon successful authentication, the payer system can send XML back indication authentication successful. The system can then send XML with the search information needed (for instance, subscriber ID, date of service, billed amount, etc.). The payer can then respond with the appropriate claim, eligibility, explanation of benefits, etc. information.

Another functionality of the systems and methods described herein includes an auditing capability. Data from 2 or more systems can be audited and results reported back to agents. After completing the audit, the system prioritizes, highlights, and presents data in the way that's best suited for each entity. Each claim, eligibility, and/or benefits item will go through a field by field, line by line, and item by item audit based on the criteria detailed above. Discrepancies and/or matches in fields, line items, and/or items will be prioritized, highlighted and/or marked/indicated according to the criteria based on the audit results. For instance, if one of a specific list of revision/procedure codes is found on any line item of a claim's on the payer's web site (i.e. 274, 276, or 283), color code the entire item green. If the revision/procedure code matches 321, 345, 456 or 834, color code the entire line item. Another example is if the denial/reason/explanation of benefits code matches something like “service is not a benefit,” highlight that entire line item red. Based on discrepancies, follow-on actions may also occur. For instance, filling out and/or submitting subsequent insurance forms in order to rectify the discrepancy.

A similar functionality includes a historical view of all researched claim, eligibility, etc information. Often times, a medical service/procedure will go through a series of claims and eligibility research efforts. As information is gathered, a history is created. The history can include notes by agents, electronic images, adjustments, re-billing, re-submission of claims and/or information, etc. Unlike most billers and systems, the system will aggregate all of the “historical” information associated with the claim/eligibility transactions and present a historical view of the activities associated with the claim/eligibility item. For example, the original claim may have been submitted by the primary payer on 1/1. The primary payer denied it on 1/15 for reason code 123 (missing information). The provider agent re-submitted the claim with missing information on 1/30. The primary payer paid all except $100 on 2/15. The remaining balance was submitted to the secondary payer on 2/28. The secondary payer denied the claim on 3/15 as the patient did not have coverage for that procedure. On 3/30, the billing agent discovered that the patient did have coverage, but the procedure was inaccurately written. On 4/15, the provider/billing agent resubmitted the claim to the secondary insurance company with the correct procedure code. On 4/30, the remaining $100 was paid.

Another functionality of the systems and methods described herein includes the ability to coordinate and synchronize electronic, phone (physical or virtual), and human resources. This can also provide automated and facilitated agent to agent, agent to system, system to agent and system to system communication. The system can also perform cross system/function lookups. For instance, if Medi-Cal eligibility indicates that a particular patient's insurance is Blue Cross if the date of service is after Oct. 1, 2010 and the provider's billing system knows the date of service is Mar. 1, 2011, the system can look up claims and eligibility on the Blue Cross electronic or voice sites. The system can do lookups for multiple payers. For instance, a person may have a primary, secondary, and tertiary insurance plan. The system can look up claims/eligibility for all associated plans.

Another functionality of the systems and methods described herein includes the ability to automatically fill out template forms. For example, denial codes may trigger a claims appeals form, which may be state specific as state mandates play a role in the way that claims are processed. This functionality can take stored data and enter them into forms to be used and/or submitted electronically or otherwise. For instance, the CMS1500 form. The form can be for print for hard copy submission or via electronic means (web or EDI for example) for electronic submission. An example of a form is an appeals submission.

A similar functionality is the ability to create custom disposition and note taking templates. Dispositions can include things like paid, rejected or past timely filing. Disposition templates can be created to identify characteristics within the research data collected that can be associated with a disposition. For instance, a disposition template or category can be created called “patient responsibility”. An account may be assigned to this disposition if, for example, the deductable plus the co-insurance plus the co-pay amounts are equal to or greater than the balance amount. Similarly, a disposition of “patient responsibility” could result if the patient was not eligible for coverage on the date of service. Another example of a disposition category could be “no action required”. This may occur if the claim status returned is something to the effect of “pending” or “in process” and the date of service was within the last 30 days. Note templates are used to help users documenting their findings/assessments. Notes can have templates for filling in text. For example, a note entitled “partial pay” may have a template like the following: “per the [TMHP] web site, claim number [123456789] was partially paid.” Users can create as many note and disposition templates as needed. Items in square brackets would be filled in from the research data gathered. With detailed notes, for example, a specific line item within a claim may need additional details provided beyond the disposition text. A template similar to the above could be created. For instance, “reason code [297] was given with a description of [This service cannot be rendered from this provider type].” Simply selecting a pre-defined note from a drop down would generate the actual note for that account from the template text. Further, clicking on one or more detailed line item(s) would result in the generation of more detailed, supporting text.

Another functionality of the systems and methods described herein includes the ability to operate as a software as a Service platform. A software-as-a-service platform provides functions and services necessary for receiving or sending text, audio, or visual content, leveraging, where appropriate, interactive phone communication through speech or touchtone recognition, or text-to-speech playback. The apparatus enables users to create or customize templates specific to their respective applications.

Another functionality of the systems and methods described herein includes the ability to store customized communication procedures for each entity. For insurance companies, this could include preferred internet protocol time frames, preferred internet protocol workflows, preferred IVR communication time frames, preferred IVR call paths/work flows, preferred communication mechanism prioritization (for instance, web first followed by phone), and preferred data display. Indeed, the payers could define what fields/data to display in which order for their own agents while providers can have their own customized presentation of the same data to best fit their own needs. For instance, the payer may want to see the claim number 1^{st} followed by the provider's question next. Similarly, the provider may want to see the account number first, followed by the member identification number, date of birth, and date of service. An example of a preferred call time is when a payer has less call volume on any given day/time frame of the week. For instance, let's say from 4-6 pm, the payer's call volume is reduced. This would be the time call centers would prefer to receive calls. By indicating these time frames, the provider agent can be presented with the option of calling now or have a “call back” at the preferred time frame.

And customized communication procedures for service providers could include contractual or policy data. For instance, a service provider may have a 90 day agreement with a payer in which the service provider must file an appeal once notified of a rejected claim. Another example is discounts to specific payers. For example, a provider may have a 5% contractual discount with Blue Cross of California while the same provider may have a 15% contractual discount with Blue Shield of California. Another example is some procedures may be “free of charge”. For instance, blood draw fees are free of charge.

The customized communication procedures for service providers could also include field selection and audit criteria. For instance, compare the “total charges amount” field from the provider's system to the “total amount billed” field from the payer's web site. Also, it could indicate when the two amounts differ by more than $1.00.

The customized communication procedures for service providers could also include an identification function indicating which fields/items match the search criteria and/or which items do not match (are discrepant) For instance, looking line by line in the payer's system for codes/messages indicating the provider needs to take action. An example for criteria is any line item in the payer's system where the paid amount is zero. In some configurations, these messages could be normalized. For instance, multiple payers may have slightly different codes/message indicating the same course of action for a provider.

The customized communication procedures for service providers could also include key dates and/or fields. For instance, a contract between a payer and service provider may specify that the service provider must file an appeal within 90 days from being notified of the payer's rejection of the claim. The notification date, in this example, is posted on the payer's web site in the “finalized date” field. Examples include timely filings and appeals dates/deadlines.

The customized communication procedures for service providers could also include calculations. In the “appeals” example above, calculating and reporting the number of days remaining prior to the expiration of the 90 days. For instance, there may be 1 day remaining before the appeals deadline. Another example is calculating the amount to be billed. For instance, for a billed amount of $100, the insurance company may be required to cover 80% after a $20 co-pay. The bill to the insurance company could be 80% of $80.00 or ($64.00). Another example is secondary, tertiary insurance, as well as patient/self pay. Calculating the proper amount to bill each party based on coverage/eligibility and any previously paid amounts (such as deductible) and presenting the proper billing breakdowns.

The customized communication procedures for service providers could also include match logic. The determination of the logic that determines which claims from a search match the claim to be researched. Examples include matching service rendered dates within 1 business day or matching the amount billed fields within 1 dollar.

The customized communication procedures for service providers could also include prioritization. Prioritization of workflow can be based on any parameter, such as search and audit criteria. As an example, if a customized message is found indicating provider action, make it a high priority. If it's past the timely filing date, make it a low priority. If it doesn't match a search code/message and is not past the timely filing date, make it a medium priority. If the appeals deadline is within 14 days of today, make it a high priority.

The customized communication procedures for service providers could also include highlighting/marking to bring certain parts of the data to the attention of the service provider. This could bring the user's attention to particular items of interest. For instance, a user may want to have an indication of when the provider's and payer's respective billed amounts don't match. Another example is the provider agent may want a line item highlighted if the paid amount is zero. Another example is specific revision, procedure, denial, reason, or explanation of benefits codes. For instance, if one of a specific list of revision/procedure codes is found on any line item of a claim on the payer's web site (i.e. 274, 276, or 283), color code the entire item green. If the revision/procedure code matches 321, 345, 456 or 834, color code the entire line item. Another example is if the denial/reason/explanation of benefits code matches something like “service is not a benefit,” highlight that entire line item red.

The customized communication procedures for services providers could also include question input and queries. The provider will be able to enter/record their specific questions pertaining to a given claim or eligibility request. The question can then be stored and later displayed to both the payer and provider agents as needed.

Another functionality of the systems and methods includes the ability to enhance billing processes. The enhanced billing could include efficiencies in uploaded line items, Web service or EDI lookups, phone calls made, minutes for phone calls, data presentment, and deflections (charging based on an electronic lookups that don't result in a phone call made). This also includes the ability for a payer to pay a portion or the entirety of a service provider's bill. This can also be based off of provider performance criteria.

Another functionality of the systems and methods includes the ability to create a feedback community. This would involve compiling a list of the most successful of the criteria and/or parameters and recommending those to other users.

Another functionality of the systems and methods includes the ability to create secure data and communication mechanisms. Indeed, the data can be sent and received via a combination of EDI, IVR, and/or internet protocol integration, or through APIs, including web-based URL APIs.

Another functionality of the systems and methods includes the ability to rationalize and/or normalize the data and store them in a database. This allows the ability to apply the rules/preferences in order to determine the best mode of communication, apply the rules/preferences in order to determine priorities, apply the rules/preferences in order to determine items to flag or highlight, and apply customized workflows for the desired mode of communication.

Another functionality of the systems and methods includes the ability to enhance the communication between the various users of the system. This also includes key portions of the data to be sent via the desired mode of communication and workflow. It also allows correspondence to be received back from the recipient entity. It can also apply the received correspondence to the originating entities preferred custom communication interface. It can also present the data to entities as requested. For instance, present web, voice, or EDI information to the agent in a user friendly format. This can include the presentment of multiple claims or eligibility items to a human agent in one screen. This can also include showing either customized data presentation or identical/mirrored data. In this later case, the payer and provider agents would literally be “on the same page” and see the same information, including the specific question (if provided) that the provider entered/needs answered.

Another functionality of the systems and methods includes the ability to record and log all activity and correspondence. Another functionality of the systems and methods includes the ability to enhance search performance. This could include perform coordinated or alternate searches, as necessary. For example, if a BCCA claim is not found, try an “out of state” search next. If still not found, try Blue Shield of California. Further, after the claim is found, perform the eligibility research as well as the benefits research. Another example is if a claim is not found for a specific date of service. In this case, extend the dates of service to be one day prior and one day after the noted date of service. Another example is if a claim is not found for a specific dollar amount. In this case, possibly still search on the subscriber ID, date of service, but don't include the billed amount in the search. This helps find claims where the billed amount was miss-typed into the payer or provider system.

Another functionality of the systems and methods includes the ability to create activities, whether custom or generic. An activity may be something like “add note” which would automatically add a note or provide an audit trail to the system of record. A corresponding button, radio button, drop-down list, etc. would be presented to the agent that would perform the requested task. Another example of an activity would be “submit appeal.”

Another functionality of the systems and methods includes the ability for branding and white labeling. This functionality allows other companies to utilize components of the system or the system in its entirety with the licensing company's logos, branding, look, and feel. A similar functionality is enhanced advertising and messaging. This could include the use of screen space or phone time to deliver advertisements or messages.

Another functionality of the systems and methods includes the ability for enhanced scheduling. This functionality includes coordination of integration/communication components such as the voice, web, and EDI preferred paths. The scheduler could utilize the preferences noted above. For instance, if a payer's call center is closed, alert the provider's agent accordingly. The scheduler could also use a time based triggering mechanism since some tasks require activation or triggering at specific times of the day. For instance, a payer's agents may have low phone traffic at a particular time of the day. The system can offer the provider's agent the option for return call times at the times of day that are off-peak hours for the payer. If the provider's agent selects one of the scheduled return times, the systems can trigger calls during the selected/preferred times. The systems can also batch up and present a series of claims or eligibility requests per call. The scheduler can also be used to and from entity attributes/status. For instance, if the “to” entity's web site is down, the web integration function will notify the scheduler that the entity's web site is down. The scheduler can then take the appropriate action. For instance, instead of launching thousands of web requests to that entity, possibly trying one every 10 minutes until the web site is available again. Once available, launch a larger volume of requests. Similarly, controls are put in place for the “from” entity. For example, if the “from entity” changes its web password and does not update the system, the web integration function of the system will notify the scheduler that the password is no longer valid. The scheduler could then take the appropriate action. For example, not launch any more web inquiries from the specific “from” entity to the specific “to” entity (whose password has changed) until the password is updated. Another example is call center hours of operation. The scheduling function can also assess historical research data and manage resources accordingly. For instance, if a hospital expects 24 hour return time and the hospital sends a file of 10,000 accounts to look up, the scheduler can determine the fastest hours of the day for each payer system to perform the research. The scheduler then can target the most efficient times and automatically adjust the throughput resources to perform the research at the optimal time(s).

Another functionality of the systems and methods includes the ability for enhanced phone capabilities. This functionality includes the ability to automatically place outbound calls and receive inbound calls and the ability to apply voice prompts and/or touch tone responses to interact with and navigate IVRs. The hold time can be reduced and/or eliminated based on call recipient's interactions. For instance, a payer agent can receive a phone call with optional screen pop with questions. When the payer agent has completed their research of the claims, they could press “1” on their telephone keypad when they are ready to talk or chat with the provider agent. Upon pressing “1,” the provider agent would be contacted. As such, the provider agent wouldn't experience any “hold time.” This functionality also includes the ability to record agent or IVR spoken interactions, including whole call recording and the recording of specific data being played back. This functionality also includes a UI to play back recordings and perform appropriate actions/activities. For example, some insurance companies provide “self service IVR's.” These are phone systems that will request information from the caller and automatically provide information back to the caller via voice/phone. The solution can navigate the payer's IVR, automatically answering the IVR's questions, and record the information that the payer's IVR returns. The solution can then present those saved recordings in a User Interface to the agent. The agent can then click to hear the IVR's information without having to navigate the IVR themselves. Further, as the voice technology is integrated with notes and actions/activities, users can then take the next appropriate action after listening to the requested information.

Another functionality of the systems and methods includes the ability for improved chat capabilities. When it is determined to be the preferred mechanism of communication, the chat function can be used. The chat communications also includes the standard or customized displays of multiple claims/eligibility requests and questions, as described above.

Another functionality of the systems and methods includes the ability for enhanced administration control. These administrative functions include the ability to sign up (companies can sign their company up to start utilizing the system via the web as well as administer the following), add/remove users, password maintenance, creating/editing business rules including prioritization, highlighting, match logic, etc., managing key dates/deadlines (e.g., appeals and timely filings deadlines), controlling the billing system used, controlling the contractual agreements such as discount rates and or specific procedure or bundled code pricing, and controlling hours of agent availability, hours of IVR phone system availability, hours of web service availability, etc.

Another functionality of the systems and methods include enhanced reporting actions. Some examples of the reports that can be issued by the systems include but are not limited to call deflection rates, performance levels, and periodic claims/eligibility reports. Periodic claim and/or eligibility reports can run, for instance, daily, weekly or monthly. They can perform an audit of all claims or eligibility activity for a medical practice/entity. For instance, let say there's a doctor's office that is in a rural part of the country that does not have internet access. The system can perform a weekly check of all of the claims filed by that entity and then fax (see below) the report back to the doctor's office. The report could indicate the status and appeals deadline of each claim submitted by that particular office. The report could also provide insights into each specific denial.

Other reports that can be generated by the system include those about Time-based Transactions, i.e., frequency count of web- or phone-based activity by time duration (e.g., hour, day, week, or month). Other reports include those about operational behavior: frequency count of activity by operational unit; e.g., individual, team, group, site, multi-site, etc. Other reports include Value Reports: correlations to monetary value; e.g., value of claims associated with activity (web- or phone-based inquiries), as tied to, for example, time duration, operational unit, insurance payer, provider, etc. Other reports include category reports: reports correlated to certain data attributes associated with the member profile, eligibility and benefits, claim status, payment and/or denial reasons, and/or explanation of benefits (EOBs). These reports could comprise tabular and/or graphical presentation, such as a “pie-chart” showing a categorization of claim status attributes, or a bar-chart showing frequency or value across various claim or operational categories. Other reports include root-cause analysis reports: identify correlations to driving root causes for resulting claim status categories. For example, identifying data discrepancies in patient demographics, diagnosis and/or procedure codes, or billing information that may cause resulting and associated adjudication decisions by the payer.

Yet other reports that can be generated by the system include those about performance levels. These could include agent performance levels (e.g., the number of claims an agent works or resolves per day, week, or month) as well as provider performance levels. For example, how fast return phone calls and/or chats are answered. Another example is electronic resolution rates. These are items that are resolved without the need to make a phone call (and are also referred to as deflection rates). Yet another example is how many times a particular provider or provider's agent calls on different types of claims and/or denial/reason/EOB (explanation of benefits) codes.

The performance level reports could also be about payer performance levels. For example, how often a payer is prepared prior to making the return phone call. Another example is if the payer participates in the “no hold time” opt-in functionality or not. Other examples include the number of follow ups to a payer prior to resolution and the length of time payers or payer agents keep provider agents on hold. Yet other examples include payer rating systems. Provider agents can rate and provide feedback on payers and specific payer agent performance. In this example, there can be a number of questions rating their performance. A simple example, for illustration purposes, is asking a yes or no question about whether the payer agent called the provider agent prepared with the appropriate answers/questions needed. A “payer prepared” rating of 95% or higher could be a “platinum” rating, while a “payer prepared” rating of 90-94.9% could be a “gold” rating, and so on. Another example of payer rating system reports is about certification Levels.” The more a payer, for example, integrates with the Advance Response system, the higher certification levels.

Another functionality of the systems and methods include enhance eligibility and benefits information to find out coverage/specifics, and apply those to collectable amounts. Another functionality of the systems and methods include a batching ability. This functionality allows multiple claims or eligibility/benefits can be batched into one call or communication method.

Another functionality of the systems and methods include the web to phone feature and API. For instance, a payer can put a “call now” button in the provider's or member's section of web site. This “call now” button would send the IVR navigation information to the Advance Response system, such as via a web-based URL containing field to pass the desired patient and/or claim information. The system would call a predetermined phone number to the payer and enter in the information sent (if any) into the payer's IVR, navigating accordingly.

Another functionality of the systems and methods include a complete view of claims eligibility and coordination of benefits. When a medical claim is created, often times, there are multiple insurance companies involved. Whether partially or fully paid by the primary insurance company, secondary insurance company, other insurance companies, the patient, written off, or allocated to other “buckets” such as denied or charity/financial assistance, the total amount needs to be accounted for to the penny. This feature shows a single view of the complete, up to date breakdown of all associated claims/dollars.

This coordination functionality also incorporates the notes, workflow, and/or activities features above. For instance, a portion of the total bill may be a “write-off.” The user can identify the portion to be written off and select the “write-off” activity. The “write off” activity may make a note as well as send the system of record the corresponding transaction/status changes. Primary, secondary, tertiary, etc. plus patient responsibility will all be portrayed as well as amounts such as total billed amount, contractual discounts, write-off amount, allowed amount, co-insurance, co-pay, deductible, paid amount, adjusted amount, remaining balance, patient responsibility and other characteristics like eligibility/verification/coverage on the date of service by each insurance company involved and benefit/coverage details.

This coordination functionality can also include in line edits. For example, if the contractual agreement for a specific procedure code is “no charge” and the system administrator has not updated the contractual rules yet, the agent can adjust/edit the amounts accordingly and leave a note/audit trail. The system will record the audit trail and adjust the affected calculations accordingly.

This coordination functionality can also integrate the contractual or policy data above as well as the algorithms needed to audit the correct aforementioned amounts. For example, when the “allowed amount” is “total billed amount” minus the “contractual discounts”, the patient's responsibility is the allowed amount minus (unpaid deductibles and/or co-insurance). The primary payer's responsibility is the allowed amount minus the patient's responsibility. For the secondary payer, the same calculations hold true except that the secondary payer's responsibility starts from the patient's responsibility. In simple terms, in this case, the secondary payer (if the secondary insurance covers 80% of the patient's costs) would pay 80% of the patient's portion from the primary payer. And the tertiary payer is similar to the secondary except it would pay the agreed portion of the patient's responsibility from the secondary payer. This complete view will also allow the user to view the details of each claim and/or eligibility/benefits details.

A similar functionality includes claim/check reconciliation. A claim or refund may be paid in part, in full, and/or sometimes inaccurately on one or more “bulk” checks. A bulk check is a check that has more than one claim or refund that is being paid in one check. In these cases, it's often difficult to account for the proper payments for claims/refunds across multiple adjustments on multiple checks. For instance, let's say there are 2 claims. The first claim is for $100 and the second claim is for $200. Both claims are paid at 80% on a check at the end of the month. So, a “bulk” check is written for $240 at the end of the month. As it turns out, the first claim was over paid by $20. The next month, there are 2 more claims. One for $300 and another for $400. Both of those claims are paid at 80% for a total of $560 with a reduction of $20 for the overpayment on the $100 claim. In this case, the $100 billed claim (that should have $60 paid) will have a payment of $80 on one check as well as an adjustment of −$20 on the 2^{nd} check. The system will be able to perform a claim to check reconciliation. It will be able to take each payment line item to each entity and total those line items up. It will then reconcile the line items and/or totals against various payment and/or refund checks. It will then identify/report which claims/refunds/line items have been reconciled properly and which ones have not. Discrepant claims/line items will have the detailed claim or remittance information/explanations/explanation codes associated with it. Users will be able to create notes and make adjustments on the screen as needed. An audit trail will be created including check/electronic funds numbers, etc. Results/adjustments/notes can be exported to external systems.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

1. A method for processing a medical claim, comprising:
receiving claim data about medical services from an information source comprising a patient, a medical provider, or a billing service;
placing the data into a database;
searching via web portal or voice system for additional data related to the claim from the same information source or another information source;
standardizing the data into a common database schema by mapping the data from the web site into database values using a right-to-left and top-to-bottom routine;
presenting the data in an organized user interface template, in an API, or in a result file;
configuring the database to allow the information source or another information source to interactively search, filter, or sort the standardized data; and
using the standardized data to resolve the medical claim.

2. The method of claim 1, wherein the claim data comprises eligibility data.

3. The method of claim 1, wherein the claim data is used to track operational or financial metrics.

4. The method of claim 1, further comprising normalizing the claim data from any information source from which claim data has been received.

5. The method of claim 1, further comprising standardizing the data into a common database schema by parsing the data from the voice system into the database using silence recognition to determine a decision path and trigger a data entry.

6. The method of claim 5, further comprising using the standardized data mapped from the web site during the process of parsing the data from the voice system.

7. The method of claim 5, further comprising using the standardized data parsed from the voice system during the process of mapping the data from the web site.

8. A method for processing a medical claim, comprising:
receiving claim data about medical services from an information source comprising a patient, a medical provider, or a billing service;
placing the data into a database;
searching via web portal or voice system for additional data related to the claim from the same information source or another information source;
standardizing the data into a common database schema by parsing the data from the voice system into the database using silence recognition to determine a decision path and trigger a data entry;
presenting the data in an organized user interface template, in an API, or in a result file;
configuring the database to allow the information source or another information source to interactively search, filter, or sort the standardized data via a user interface; and
using the standardized data to resolve the medical claim.

9. The method of claim 8, wherein parsing the data from the voice system comprises interactively navigating the IVR system of the information source.

10. The method of claim 9, wherein parsing the data from the voice system comprises using timing sequences to determine when an input can be entered in the IVR system.

11. The method of claim 8, wherein the claim data comprises eligibility data.

12. The method of claim 8, wherein the claim data is used to track operational or financial metrics.

13. The method of claim 8, further comprising normalizing the claim data from any information source from which claim data has been received.

14. The method of claim 8, further comprising standardizing the data into a common database schema by mapping the data from the web site into database values using a right-to-left and top-to-bottom routine.

15. The method of claim 14, further comprising using the standardized data mapped from the web site during the process of parsing the data from the voice system.

16. The method of claim 14, further comprising using the standardized data parsed from the voice system during the process of mapping the data from the web site.

17. A method for processing a medical claim, comprising:
receiving claim data about medical services from an information source comprising a patient, a medical provider, or a billing service;
placing the data into a database;
searching via web portal or voice system for additional data related to the claim from the same information source or another information source;
standardizing the data into a common database schema by mapping the data from the web site into database values using a right-to-left and top-to-bottom routine and by parsing the data from the voice system into the database using silence recognition to determine a decision path and trigger a data entry;
presenting the data in an organized user interface template, in an API, or in a result file;
configuring the database to allow the information source or another information source to interactively search, filter, or sort the standardized data; and
using the standardized data to resolve the medical claim.

18. The method of claim 17, further comprising using the standardized data mapped from the web site during the process of parsing the data from the voice system.

19. The method of claim 17, further comprising using the standardized data parsed from the voice system during the process of mapping the data from the web site.
